(19) United States
(12) Patent Application Publication
(10) Pub. No.: US 2011/0014100 A1
(43) Pub. Date: Jan. 20, 2011

(54) Carbon Sequestration Using Ionic Liquids

(76) Inventors: Jason E. Bara, Denver, CO (US); Dean E. Camper, Superior, CO (US); Christopher J. Gabriel, Boulder, CO (US)

Correspondence Address: Riverside Law LLP, 300 Four Falls Corporate Center, Suite 710, 300 Conshohocken State Road, West Conshohocken, PA, 19428, US

(21) Appl. No.: 12/624,726

(22) Filed: Nov. 24, 2009

Related U.S. Application Data
(63) Continuation-in-part of application No. 12/470,420, filed on May 21, 2009.
(60) Provisional application No. 61/055,135, filed on May 21, 2008.
(60) Provisional application No. 61/121,849, filed on Dec. 11, 2008.

(51) Int. Cl. B01D 53/62; C01B 31/20

(52) U.S. Cl. 423/229; 423/228; 423/437.1

(57) ABSTRACT

A process to capture and sequester an impurity gas from a fluid stream. The impurity gas capture is accomplished by contacting the fluid stream with an impurity removing mixture, the mixture comprising an ionic liquid and an amine compound under conditions sufficient to reduce the amount of impurity gas from said fluid stream. The captured impurity gas is sequestered by reacting the impurity gas with a sequestration material.

### CROSS-REFERENCE TO RELATED APPLICATIONS

This application is a continuation-in-part of U.S. patent application Ser. No. 12/470,420, filed May 21, 2009, which claims the priority benefit of U.S. Provisional Application No. 61/055,135, filed May 21, 2008 and of U.S. Provisional Application No. 61/121,849, filed Dec. 11, 2008, each of which is incorporated herein by reference in its entirety.

### STATEMENT REGARDING FEDERALLY FUNDED RESEARCH

The U.S. Government has a paid-up license in this invention and the right in limited circumstances to require the patent owner to license others on reasonable terms as provided for by the terms of Grant Nos. AB07CBT010 and HDTRA1-08-1-0028 awarded by U.S. Army Research Office and Grant No. DMR-0552399 awarded by the National Science Foundation.

### FIELD OF TECHNOLOGY

The present application discloses compositions comprising an ionic liquid and an amine compound, and methods for using and producing the same. In some embodiments, the compositions disclosed herein are useful in reducing the amount of an impurity in a fluid medium or from a solid substrate.

### BACKGROUND

Ionic liquids are “green” materials with great potential to replace the volatile organic solvents used throughout industrial and laboratory settings. An ionic liquid is a liquid that contains essentially only ions. Some ionic liquids, such as ethylammonium nitrate, are in a dynamic equilibrium where at any time more than 99.99% of the liquid is made up of ionic rather than molecular species. The term “ionic liquid” is commonly used for salts whose melting point is relatively low (e.g., below 100° C.). The salts that are liquid at room temperature are called room-temperature ionic liquids, or RTILs. RTILs possess obvious advantages over traditional solvents when considering user safety and environmental impact. Under many conditions, RTILs have negligible vapor pressures, are largely inflammable, and exhibit thermal and chemical stability. However, it is the ability to tailor the chemistry and properties of an RTIL solvent in a variety of ways that provide more useful features, for example, modifying the ionic liquid to modulate the solubility of an amine compound and/or the impurity.

Improved and highly efficient separations of “light” gases (e.g., CO₂, O₂, N₂, CH₄, H₂, and hydrocarbons) are important as fuel use, demand, and costs rise. RTILs have been investigated in other energy-intensive technologies, such as amine scrubbing, for the capture of “acid” gases (CO₂, H₂S, SO₂, etc.). The presence of acid gases in many natural gas fields around the world negatively impacts the quality and viability of those sources.

Recently there has been great interest in CO₂ capture and sequestration, stemming from the immediate need to reduce greenhouse gas emissions. It is estimated that cuts of over 60% in such emissions would be needed to stabilize the climate. Most CO₂ capture studies are currently looking at capturing CO₂ at atmospheric pressures from coal or gas-fired gas plants. Removal of additional impurities from flue gas, such as CO, nitrogen oxides and sulfur oxides, has also been targeted. The most viable method, in the near-term, to accomplish this post-combustion capture, particularly of CO₂, is through chemical absorption, a process where there is substantial room for improvement.

CO₂ removal from natural gas is useful to increase the energy content per volume of natural gas and to reduce pipeline corrosion. H₂S removal from natural gas is also important because H₂S is extremely harmful and can even be lethal; H₂S combustion leads to the formation of SO₂, another toxic gas and a component leading to acid rain. Amine-based “scrubbing” is used in 95% of U.S. natural gas “sweetening” operations. In this process, CO₂ (and H₂S) react with amines to form an aqueous carbamate. CO₂ (and H₂S) can be released if the solution is heated and/or the partial pressure reduced.

Generally, the capture of acid gases from natural gas is performed at higher pressures than from post-combustion processes. Typically, the capture pressure is greater than 1 atm, and often at least about 6 atm. In some cases, the type of amine effective in a given application is related to the partial pressure of the acid gas in the stream with primary (1°) alkanolamines (e.g., monoethanolamine (MEA)), secondary (2°) alkanolamines (e.g., diethanolamine (DEA)), and tertiary (3°) alkanolamines (e.g., triethanolamine (TEA)) being suited for low, moderate and high pressures, respectively. In some instances, tertiary amines can also separate H₂S from CO₂. While the amine-based scrubbing process is effective for separating CO₂ from other gases, it is energy-intensive.

Accordingly, there is a need for a method that is more energy efficient in removing impurities or undesired substances from a fluid medium.

### SUMMARY

Some aspects of the present application relate to compositions and to methods for reducing or removing an impurity and/or undesired material from a source comprising contacting the source with such a composition. One aspect is a method for reducing the amount of an impurity gas in a fluid stream, the method comprising contacting the fluid stream with an impurity removing mixture comprising: an ionic liquid and an amine compound, under conditions sufficient to reduce the amount of impurity gas from the fluid stream; wherein the ionic liquid comprises a non-carboxylate anion; and the amine compound is a monoamine, a diamine, a polyamine, a polyethylene amine, an amino acid, a neutral N-heterocycle or a neutral N-heterocyclic-alkyl-amine.

Another aspect of the present application is a method for reducing the amount of one or more impurities from a gaseous emission stream, the method comprising contacting the gaseous emission stream with an impurity removing mixture comprising an ionic liquid and an amine compound under conditions sufficient to reduce the amount of one or more impurities from the gaseous stream.

In one aspect, the present application discloses a composition comprising an ionic liquid (IL) and a heteroalkylamine compound wherein the ionic liquid comprises an anion selected from the group consisting of MeSO₄, OTf, BF₄, PF₆, Tf₂N, halide, dicyanamide, tricyanomethane, alkyl sulfonate and aromatic sulfonate.

In another aspect, the present application discloses a composition comprising an ionic liquid and an amine compound, wherein the relative volume % of the ionic liquid compared to the total volume of the ionic liquid and the amine compound is about 60 vol % or less, wherein the ionic liquid comprises an anion selected from the group consisting of MeSO₄, OTf, BF₄, PF₆, Tf₂N, halide, dicyanamide, tricyanomethane, alkyl sulfonate and aromatic sulfonate and wherein the amine compound is a monoamine, a diamine, a polyamine, a polyethylene amine, an amino acid, a neutral N-heterocycle or a neutral N-heterocyclic-alkyl-amine.

In yet a further aspect, the present application discloses a method for removing an impurity from a solid substrate surface to produce a clean solid substrate surface comprising contacting the solid substrate surface with an impurity removing mixture under conditions sufficient to remove the impurity from the solid substrate surface to produce a clean solid substrate surface; the impurity removing mixture typically comprises an ionic liquid and an amine compound.

In yet another aspect, the present application discloses a method for removing an impurity from a fluid medium to produce a purified fluid stream. The method generally comprises contacting the fluid medium with an impurity removing mixture disclosed herein under conditions sufficient to remove the impurity from the fluid medium to produce a purified fluid stream.

### BRIEF DESCRIPTION OF THE DRAWINGS

FIG. 1 is a schematic representation of a typical aqueous amine gas treatment unit.

FIG. 1A is a schematic representation of an alternative embodiment of an aqueous amine gas treatment unit.

FIG. 2 is a graph of CO₂ uptake as a function of pressure in 2a and in an equimolar compound 2a-MDEA solution.

FIG. 3A is a graph of CO₂ pressure data for uptake in an equimolar compound 2a-MEA solution.

FIG. 3B is a graph of CO₂ conversion to MEA-carbamate as a function of time.

FIG. 4 is a plot of the release of CO₂ from MEA-carbamate in compound 2a at 100° C. under reduced pressure as a function of time.

FIG. 5 is a graph showing increased CO₂ uptake in compound 2b-DEA at 100° C. with increasing pressure of CO₂.

FIG. 6 is a plot of Average natural log of the Henry's constant versus average measured mixture molar volume to the −4/3 power at 40° C., where the lines represent the regular solution theory (RST) models (eq 6) for each gas.

FIG. 7A is a plot of solubility selectivity versus average measured molar volume of the IL at 40° C. for CO₂ with N₂, where the lines represent the RST model prediction.

FIG. 7B is a plot of solubility selectivity versus average measured molar volume of the IL at 40° C. for CO₂ with CH₄, where the lines represent the RST model prediction.

FIG. 8A is a plot of gas loading at 1 atm and 40° C. as a function of molar volume for CO₂, where the line represents the RST model developed from pure RTIL solubility data.

FIG. 8B is a plot of gas loading at 1 atm and 40° C. as a function of molar volume for N₂, where the line represents the RST model developed from pure RTIL solubility data.

FIG. 8C is a plot of gas loading at 1 atm and 40° C. as a function of molar volume for CH₄, where the line represents the RST model developed from pure RTIL solubility data.

FIG. 9 is a graph showing the relationship between the carbamate precipitation point vs. vol % of IL compound.

### DETAILED DESCRIPTION

### Definitions

Unless the context requires otherwise, the terms “sequestration,” “reduction,” “removal,” and “separation” are used interchangeably herein and refer generally to techniques or practices whose partial or whole effect is to reduce the amount of or remove one or more impurities or undesired substances from a given material (e.g., a fluid medium or a solid substrate) such as gas mixtures, gas sources or point emissions sources. In some embodiments, the removed impurity and/or undesired substance (hereinafter collectively “impurity” or “impurities” unless the context requires otherwise) are stored in some form or another so as to prevent its release. Use of these terms do not exclude any form of the described embodiments from being considered impurity and/or undesired substance “sequestration,” “reduction,” “separation,” or “removal” techniques. Generally the terms “sequestration,” “reduction,” “removal,” and “separation” refer to removal of at least about 60% of an impurity from a source; alternately, about 75% of an impurity is removed. In other variations, at least about 90% or at least about 99% of an impurity is removed from s source.

Unless the context requires otherwise, the terms “impurity,” “undesired material” and “undesired substance” are used interchangeably herein and refer to a substance within a liquid, gas, or solid, which differs from the desired chemical composition of the material or compound. Impurities are either naturally occurring or added during synthesis of a chemical or commercial product. During production, impurities may be purposely, accidentally, inevitably, or incidentally added into the substance or produced or it may be present from the beginning. The terms refer to a substance that is present within a liquid, gas, or solid that one wishes to reduce the amount of or eliminate completely.

The term “acid gas” refers to any gas that reacts with a base. Some acid gases form an acid when combined with water and some acid gases have an acidic proton (e.g., pKₐ of less than that of water). Exemplary acid gases include, but are not limited to, carbon dioxide, hydrogen sulfide (H₂S), COS, sulfur dioxide (SO₂), nitrogen oxides (NOₓ) and the like.

“Alkyl” refers to a saturated linear monovalent hydrocarbon moiety of one to twenty, typically one to twelve and often one to six, carbon atoms or a saturated branched monovalent hydrocarbon moiety of three to twenty, typically three to twelve and often three to six, carbon atoms. Exemplary alkyl group include, but are not limited to, methyl, ethyl, n-propyl, 2-propyl, tert-butyl, pentyl, hexyl and the like.

“Alkylene” refers to a saturated linear saturated divalent alkyl moiety defined above. Exemplary alkylene groups include, but are not limited to, methylene, ethylene, propylene, butylene, pentylene, hexylene, and the like.

“Alkenyl” refers to a linear monovalent hydrocarbon moiety of two to twenty, typically two to twelve and often two to six, carbon atoms or a branched monovalent hydrocarbon moiety of three to twenty, typically three to twelve and often three to six carbon atoms, containing at least one carbon-carbon double bond. Exemplary alkenyls include, but are not limited to, ethenyl, propenyl, and the like.

“Alkynyl” refers to a linear monovalent hydrocarbon moiety of two to twenty, typically two to twelve and often two to six, carbon atoms or a branched monovalent hydrocarbon moiety of three to twenty, typically three to twelve and often three to six carbon atoms, containing at least one carbon-carbon triple bond. Exemplary alkynyls include, but are not limited to, ethynyl, propynyl, and the like.

“Amine compound” refers to an organic compound comprising a substituent of the formula —NR^{a}R^{b}, where each of R^{a} and R^{b} is independently hydrogen, alkyl, heteroalkyl, haloalkyl, aryl, aralkyl, cycloalkyl, (cycloalkyl)alkyl, heteroaryl, heteroaralkyl, heterocycloalkyl, or (heterocycloalkyl)alkyl. Typically, each of R^{a} and R^{b} is independently hydrogen, alkyl, heteroalkyl, haloalkyl, aryl, aralkyl, cycloalkyl, or (cycloalkyl)alkyl. Often each of R^{a} and R^{b} is independently hydrogen, alkyl, heteroalkyl, or haloalkyl. More often each of R^{a} and R^{b} is independently hydrogen, alkyl, or heteroalkyl. The amine compound can also include heterocyclic amine compounds such as piperazine, imidazole, pyridine, oxazole, thiazole, etc. each of which can be optionally substituted. “Monoamine compound” refers to an organic compound having one —NR^{a}R^{b} substituent and “diamine compound” refers to an organic compound having two —NR^{a}R^{b} substituents, where each of R^{a} and R^{b} is independently those defined in this paragraph.

“Alkyl amine compound” refers to a hydrocarbon compound comprising a substituent of the formula —NR^{a}R^{b}, where each of R^{a} and R^{b} is independently hydrogen, alkyl, haloalkyl, aryl, aralkyl, cycloalkyl, or (cycloalkyl)alkyl. Typically, each of R^{a} and R^{b} is independently hydrogen, alkyl, aryl, aralkyl, cycloalkyl, or (cycloalkyl)alkyl. Often each of each of R^{a} and R^{b} is independently hydrogen or alkyl.

“Heteroalkyl amine compound” refers to an amine compound as defined herein in which R^{a} is a heteroalkyl group. In particular, heteroalkyl amine compound refers to an organic compound comprising a substituent of the formula —NR^{a}R^{b}, where R^{a} is heteroalkyl, and R^{b} is hydrogen, alkyl, heteroalkyl, haloalkyl, aryl, aralkyl, cycloalkyl, (cycloalkyl)alkyl, heteroaryl, heteroaralkyl, heterocycloalkyl, or (heterocycloalkyl)alkyl. Typically, R^{a} is heteroalkyl, and R^{b} is hydrogen, alkyl, heteroalkyl, haloalkyl, aryl, aralkyl, cycloalkyl, or (cycloalkyl)alkyl. Often R^{a} is heteroalkyl, and R^{b} is hydrogen, alkyl, heteroalkyl, or haloalkyl. More often R^{a} is heteroalkyl, and R^{b} is hydrogen, alkyl, or heteroalkyl. Still more often R^{a} is heteroalkyl, and R^{b} is hydrogen or alkyl.

“Heterocyclic” and “heterocycle” refer to aromatic or non-aromatic cyclic groups of 3 to 6 atoms, or 3 to 10 atoms, containing at least one heteroatom. In one embodiment, these groups contain 1 to 3 heteroatoms. Suitable heteroatoms include oxygen, sulfur, and nitrogen. Such groups can be optionally substituted. Exemplary heterocyclic groups include, but are not limited to pyrrolidinyl, piperidinyl, morpholinyl, piperazinyl, pyridinyl, pyridyl, furanyl, thiophenyl, thiazolyl, isothiazolyl, triazolyl, imidazolyl, isoxazolyl, pyrrolyl, pyrazolyl, pyrimidinyl, benzofuranyl, isobenzofuranyl, benzothiazolyl, benzoisothiazolyl, benzotriazolyl, indolyl, isoindolyl, benzoxazolyl, quinolyl, isoquinolyl, benzimidazolyl, benzisoxazolyl, benzothiophenyl, and dibenzofuran.

“N-Heterocycle” and “neutral N-heterocyclic” each refers to aromatic or non-aromatic cyclic groups of 3 to 6 atoms, or 3 to 10 atoms, containing at least one nitrogen atom. In one embodiment, these groups contain 1 or 2 additional heteroatoms; suitable additional heteroatoms include oxygen, sulfur, and nitrogen. Exemplary N-heterocycles include, but are not limited to pyrrolidine, morpholine, morpholinoethyl, piperazine, pyridine, imidazole, thiazole, isothiazole, triazole, pyrazole, oxazole, isoxazole, pyrrole, pyrazole, pyrimidine, benzothiazole, benzoisothiazole, benzotriazole, indole, isoindole, benzoxazole, quinole, isoquinole, benzimidazole, and benzisoxazole.

“Neutral N-heterocyclic-alkyl-amine” refers to Y—R^{w}—NR^{a}R^{b}, where Y is an N-heterocycle, R^{w} is an alkylene group and —NR^{a}R^{b} is as defined herein. The nitrogen-containing heterocycle can be bound to the alkylene via either a carbon atom or a nitrogen atom, generally via a carbon atom. The alkylene group generally comprises one to eight carbon atoms, alternately three to six carbon atoms or one to four carbon atoms.

“Alkanolamine compound” refers to an amine compound as defined herein in which R^{a} is an alkanol group. In particular, alkanolamine compound refers to an organic compound comprising a substituent of the formula —NR^{a}R^{b}, where R^{a} is alkanol, and R^{b} is hydrogen, alkyl, heteroalkyl, haloalkyl, aryl, aralkyl, cycloalkyl, (cycloalkyl)alkyl, heteroaryl, heteroaralkyl, heterocycloalkyl, or (heterocycloalkyl)alkyl. Typically, R^{a} is alkanol, and R^{b} is hydrogen, alkyl, heteroalkyl, haloalkyl, aryl, aralkyl, cycloalkyl, or (cycloalkyl)alkyl. Often R^{a} is alkanol, and R^{b} is hydrogen, alkyl, heteroalkyl, or haloalkyl. More often R^{a} is alkanol, and R^{b} is hydrogen, alkyl, or heteroalkyl. Still more often R^{a} is alkanol, and R^{b} is hydrogen, alkyl, or alkanol.

“Aryl” refers to a monovalent mono-, bi- or tricyclic aromatic hydrocarbon moiety of 6 to 15 ring atoms which is optionally substituted with one or more, typically one, two, or three substituents within the ring structure. When two or more substituents are present in an aryl group, each substituent is independently selected. Exemplary aryl groups include phenyl and naphthyl. Often an aryl group is an optionally substituted, more often unsubstituted, phenyl group. Exemplary substituents of an aryl group include halide, alkoxy, and alkyl.

“Aralkyl” refers to a moiety of the formula —R′—R″ where R′ is an alkylene group and R″ is an aryl group as defined herein. Exemplary aralkyl groups include, but are not limited to, benzyl, phenylethyl, 3-(3-chlorophenyl)-2-methylpentyl, and the like.

“Cycloalkyl” refers to a non-aromatic, typically saturated, monovalent mono- or bicyclic hydrocarbon moiety of three to ten ring carbons. The cycloalkyl can be optionally substituted with one or more, typically one, two, or three, substituents within the ring structure. When two or more substituents are present in a cycloalkyl group, each substituent is independently selected. Often a cycloalkyl group is a saturated monocyclic hydrocarbon moiety; such moieties include, but are not limited to cyclopropyl, cyclobutyl, cyclopentyl, and cyclohexyl.

“(Cycloalkyl)alkyl” refers to a moiety of the formula —R^{x}—R^{y}, where R^{y} is cycloalkyl, and R^{x} is alkylene or heteroalkylene as defined herein. Typically R^{x} is alkylene.

The terms “halo,” “halogen” and “halide” are used interchangeably herein and refer to fluoro, chloro, bromo, or iodo.

“Haloalkyl” refers to an alkyl group as defined herein in which one or more hydrogen atom is replaced by same or different halo atoms. The term “haloalkyl” also includes perhalogenated alkyl groups in which all alkyl hydrogen atoms are replaced by halogen atoms. Exemplary haloalkyl groups include, but are not limited to, —CH₂CI, —CF₃, —CHFCH₂F, —CH₂CF₃, —CH₂CCI₃, and the like.

“Haloalkylene” refers to a branched or unbranched saturated divalent haloalkyl moiety defined above.

“Heteroalkyl” refers to a branched or unbranched, saturated alkyl moiety containing carbon, hydrogen and one or more heteratoms such as oxygen, nitrogen or sulfur, in place of a carbon atom. Exemplary heteroalkyls include, but are not limited to, 2-methoxyethyl, 2-aminoethyl, 3-hydroxypropyl, 3-thiopropyl, and the like.

“Heteroalkylene” refers to a branched or unbranched saturated divalent heteroalkyl moiety defined above.

The terms “alkanol” and “hydroxyalkyl” are used interchangeably herein and refer to an alkyl group having one or more, typically one, hydroxyl groups (—OH). Exemplary hydroxyalkyls include, but are not limited to, 2-hydroxyethyl, 6-hydroxyhexyl, 3-hydroxyhexyl, and the like.

“Heteroaryl” refers to an aryl group as defined herein in which one or more, typically one or two, and often one, of the ring carbon atom is replaced with a heteroatom selected from O, N, and S. Exemplary heteroaryls include, but are not limited to, pyridyl, furanyl, thiophenyl, thiazolyl, isothiazolyl, triazolyl, imidazolyl, isoxazolyl, pyrrolyl, pyrazolyl, pyrimidinyl, benzofuranyl, isobenzofuranyl, benzothiazolyl, benzoisothiazolyl, benzotriazolyl, indolyl, isoindolyl, benzoxazolyl, quinolyl, isoquinolyl, benzimidazolyl, benzisoxazolyl, benzothiophenyl, dibenzofuran, and benzodiazepin-2-one-5-yl, and the like.

“Heteroaralkyl” refers to a moiety of the formula —R^{m}—Rⁿ where R^{m} is an alkylene group and Rⁿ is a heteroaryl group as defined herein.

“Hydrocarbon” refers to a linear, branched, cyclic, or aromatic compound having hydrogen and carbon.

“Silyl” and “siloxy” refer to a moiety of the formula —SiR^{e}R^{f}R^{g} and —OSiR^{e}R^{f}R^{g}, respectively, where each R^{e}, R^{f}, and R^{g} is independently hydrogen, alkyl, cycloalkyl, or (cycloalkyl)alkyl or two or more of R^{e}, R^{f}, and R^{g} combine to form a cycloalkyl or (cycloalkyl)alkyl group.

“Amino acid” refers to the group of natural amino acids and their stereoisomers, as well as non-standard amino acids. Non-standard amino acids are generally synthesized through specialized enzymatic reactions from various metabolic precursors. Examples of non-standard amino acids include standard amino acids (or their derivatives) that are phosphorylated, acetylated, hydroxylated, alkylated, or carboxylated. Further included in the definition of non-standard amino acids are sulfonic acid analogs, such as taurine. Additionally included in the definition of amino acids are zwitterionic forms of amino acids as well as amino acid salts, generally of the form NHR′—CHR^{o}—COO⁻M⁺, where M⁺ is an alkali ion, such as K⁺.

“Non-carboxylate anion” refers to a negatively charged moiety that does not contain a carboxylate component.

“Protecting group” refers to a moiety, except alkyl groups, that when attached to a reactive group in a molecule masks, reduces or prevents that reactivity. Examples of protecting groups can be found in T. W. Greene and P. G. M. Wuts, Protective Groups in Organic Synthesis, 3^{rd} edition, John Wiley & Sons, New York, 1999, and Harrison and Harrison et al., Compendium of Synthetic Organic Methods, Vols. 1-8 (John Wiley and Sons, 1971-1996), which are incorporated herein by reference in their entirety. Representative hydroxy protecting groups include acyl groups, benzyl and trityl ethers, tetrahydropyranyl ethers, trialkylsilyl ethers and allyl ethers. Representative amino protecting groups include, formyl, acetyl, trifluoroacetyl, benzyl, benzyloxycarbonyl (CBZ), tert-butoxycarbonyl (Boc), trimethyl silyl (TMS), 2-trimethylsilyl-ethanesulfonyl (SES), trityl and substituted trityl groups, allyloxycarbonyl, 9-fluorenylmethyloxycarbonyl (FMOC), nitro-veratryloxycarbonyl (NVOC), and the like.

“Corresponding protecting group” means an appropriate protecting group corresponding to the heteroatom (i.e., N, O, P or S) to which it is attached.

When describing a chemical reaction, the terms “treating”, “contacting” and “reacting” are used interchangeably herein, and refer to adding or mixing two or more reagents under appropriate conditions to produce the indicated and/or the desired product. It should be appreciated that the reaction which produces the indicated and/or the desired product may not necessarily result directly from the combination of two reagents which were initially added, i.e., there may be one or more intermediates which are produced in the mixture which ultimately leads to the formation of the indicated and/or the desired product.

### Compositions

One aspect of the present application discloses a composition comprising an ionic liquid and an amine compound, wherein the ionic liquid comprises a non-carboxylate anion and the amine compound is a monoamine, a diamine, a polyamine, a polyethylene amine, an amino acid, a neutral N-heterocycle; or a neutral N-heterocyclic-alkyl-amine. Alternately, the ionic liquid comprises an anion selected from the group consisting of MeSO₄, OTf, BF₄, PF₆, Tf₂N, halide, dicyanamide, tricyanomethane, alkyl sulfonate and aromatic sulfonate. Generally the relative volume % of the ionic liquid compared to the total volume of the ionic liquid and the amine compound is about 70 vol % or less. Alternately, the relative volume % of the ionic liquid is about 60 vol % or less. In some instances, the relative volume % of the ionic liquid is about 50 vol % or less or even about 40 vol % or less.

Suitable ionic liquids for the compositions disclosed herein are salts whose melting point is relatively low (e.g., ≦100° C., typically ≦50° C.). The salts that are liquid at room temperature are called room-temperature ionic liquids, or RTILs, which are often used in compositions disclosed herein. Typically, any RTIL can be used in such compositions. Exemplary ionic liquids that are suitable for use in compositions disclosed herein include, but are not limited to, imidazolium-based RTILs (see, for example, Anthony et al., Int. J. Environ. Technol. Manage., 2004, 4, 105; Baltus et al., Sep. Sci. Technol., 2005, 40, 525; Zhang et al., AIChE J., 2008, 54, 2717; Finotello et al., J. Phys. Chem. B, 2008, 112, 2335; Kilaru et al., Ind. Eng. Chem. Res., 2008, 47, 910; Kilaru et al., Ind. Eng. Chem. Res., 2008, 47, 900; Anderson et al., Acc. Chem. Res., 2007, 40, 1208; Hou et al., Ind. Eng. Chem. Res., 2007, 46, 8166; Schilderman et al., Fluid Phase Equilibr., 2007, 260, 19; Finotello et al., Ind. Eng. Chem. Res., 2008, 47, 3453; Jacquemin et al., J. Solution Chem., 2007, 36, 967; Shiflett et al., J. Phys. Chem. B, 2007, 111, 2070; Kumelan et al., J. Chem. Thermodyn., 2006, 38, 1396; Camper et al., Ind. Eng. Chem. Res., 2006, 45, 6279; Kumelan et al., J. Chem. Eng. Data, 2006, 51, 1802; Fu et al., J. Chem. Eng. Data, 2006, 51, 371; Shiflett et al., Ind. Eng. Chem. Res., 2005, 44, 4453; Anthony et al., J. Phys. Chem. B, 2005, 109, 6366; Scovazzo et al., Ind. Eng. Chem. Res., 2004, 43, 6855; Cadena et al., J. Am. Chem. Soc., 2004, 126, 5300; Camper et al., Ind. Eng. Chem. Res., 2004, 43, 3049; Baltus et al., J. Phys. Chem. B., 2004, 108, 721; Morgan et al., Ind. Eng. Chem. Res., 2005, 44, 4815; Ferguson et al., Ind. Eng. Chem. Res., 2007, 46, 1369; and Camper et al., Ind. Eng. Chem. Res., 2006, 45, 445.), phosphonium-based RTILs (see, for example, Kilaru et al., Ind. Eng. Chem. Res., 2008, 47, 910; Kilaru et al., Ind. Eng. Chem. Res., 2008, 47, 900; and Ferguson et al., Ind. Eng. Chem. Res., 2007, 46, 1369.), ammonium-based RTILs (see, for example, Kilaru et al., Ind. Eng. Chem. Res., 2008, 47, 910; Kilaru et al., Ind. Eng. Chem. Res., 2008, 47, 900; and Jacquemin et al., J. Solution Chem., 2007, 36, 967.), pyridinium-based RTILs (see, for example, Anderson et al., Acc. Chem. Res., 2007, 40, 1208; and Hou et al., Ind. Eng. Chem. Res., 2007, 46, 8166.), phosphohonium-based RTILs, sulfonium-based RTILs, oxazolium-based RTILs, thiazolium-based RTILs, thiazolium-based RTILs, and tetrazolium-based RTILs. Compositions disclosed herein can include a single ionic liquid compound or can be a mixture of two or more different ionic compounds depending on the particular properties desired.

In one embodiment, the ionic liquid is an imidazolium-based IL, typically an imidazolium-based RTIL. Exemplary methods for producing imidazolium-based IL are disclosed in a commonly assigned PCT Patent Application entitled “Heteroaryl Salts and Methods for Producing and Using the Same,” PCT/U.S.08/86434, filed Dec. 11, 2008, which is hereby incorporated herein in its entirety. RTILs can be synthesized as custom or “task-specific” compounds with functional groups that enhance physical properties, provide improved interaction with solutes, or are themselves chemically reactive. Multiple points are available for tailoring within the imidazolium-based IL, presenting a seemingly infinite number of opportunities to design ILs matched to individual solutes of interest. Furthermore, many imidazolium-based ILs are miscible with one another or with other solvents; thus, mixtures of ILs serve to multiply the possibilities for creating a desired solvent for any particular application. Separations involving liquids or gases are just one area where the design of selective ILs is of great utility and interest.

In some embodiments, the ionic liquid comprises an imidazole core structure moiety. In one embodiment, the ionic liquid is an imidazolium-based RTIL.

In one aspect, the present application discloses a composition comprising an ionic liquid comprising a non-carboxylate anion and an amine compound selected from the group consisting of a monoamine, a diamine, a polyamine, a polyethylene amine, an amino acid, a neutral N-heterocycle and a neutral N-heterocyclic-alkyl-amine.

In one embodiment of any of the aspects disclosed herein, the ionic liquid is of

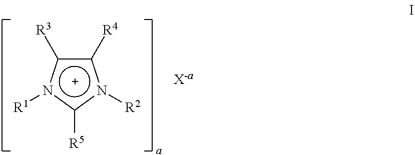

### Formula I:

wherein
a is an oxidation state of X;
X is an anion;
each of R¹ and R² is independently alkyl, heteroalkyl, cycloalkyl, haloalkyl, silyl, siloxyl, aryl, alkenyl, or alkynyl; and
each of R³, R⁴, and R⁵ is independently hydrogen, alkyl, cycloalkyl, heteroalkyl, haloalkyl, silyl, siloxyl, aryl, alkenyl, or alkynyl.

Within the imidazolium-based RTIL of Formula I, in some instances X is a non-carboxylate anion. In other instances, a is 1 and X is an anion selected from the group consisting of MeSO₄, OTf, BF₄, PF₆, Tf₂N, halide, dicyanamide, tricyanomethane, alkyl sulfonate and aromatic sulfonate; in other instances X is selected from the group consisting of OTf, BF₄, PF₆, Tf₂N, halide, dicyanamide (dca), tricyanomethane (tcm), alkyl sulfonate and aromatic sulfonate. In some instances X is selected from the group consisting of OTf, BF₄, PF₆, Tf₂N, halide, dicyanamide (dca), tricyanomethane (tcm), alkyl sulfonate and aromatic sulfonate. In one variation, X is mesylate or tosylate. In another variation, X is OTf, BF₄, PF₆, Tf₂N, dca or tcm; alternately X is Tf₂N, OTf, dca or tcm.

Within the imidazolium-based IL of Formula I, in one embodiment, R³, R⁴, and R⁵ are hydrogen. In other instances at least one of R¹ and R² is alkyl. In other instances at least one of R¹ and R² is heteroalkyl; in one variation, the heteroalkyl is a hydroxyalkyl. In some cases, the hydroxyalkyl is C₂₋₆ hydroxyalkyl. In other embodiments, haloalkyl is fluoroalkyl. Still in other embodiments, each of R¹ and R² is independently alkyl, haloalkyl, or heteroalkyl. Typically each of R¹ and R² is independently alkyl, fluoroalkyl, hydroxyalkyl, or nitrile alkyl (i.e., —R—CN, where R is alkylene). Often each of R¹ and R² is independently alkyl or hydroxyalkyl. More often, one of R¹ and R² is alkyl and the other is hydroxyalkyl.

Yet in other instances the imidazolium-based IL is of Formula IA:

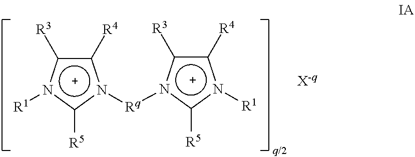

wherein
q is an oxidation state of X;
each X is an anion; and
each R′ is independently alkyl, heteroalkyl, cycloalkyl, haloalkyl, silyl, siloxyl, aryl, alkenyl, or alkynyl;
each of R³, R⁴, and R⁵ is independently hydrogen, alkyl, cycloalkyl, heteroalkyl, haloalkyl, silyl, siloxyl, aryl, alkenyl, or alkynyl; and
R^{q} is alkylene, heteoralkylene, or haloalkylene.

Within the imidazolium-based IL of Formula IA, in some instances q is 1. In some embodiments X is selected from the group consisting of OTf, BF₄, PF₆, Tf₂N, halide, and sulfonate. Still in other instances R³, R⁴, and R⁵ are hydrogen. While in other instances at least one of each R¹ is independently alkyl, heteroalkyl or haloalkyl. In other instances at least one of R¹ is heteroalkyl. In some particular embodiments, heteroalkyl is hydroxyalkyl. In some cases, the hydroxyalkyl is C₂₋₆ hydroxyalkyl. Typically, R^{q} is alkylene, generally C₂-C₁₀ alkylene and often C₂₋₆ alkylene. Still in other embodiments, each R¹ is independently alkyl, fluoroalkyl, hydroxyalkyl, or nitrile alkyl (i.e., —R—CN, where R is alkylene). Often each R¹ is independently alkyl or hydroxyalkyl. More often, one of R¹ is alkyl and the other is hydroxyalkyl.

In one variation of any of the disclosed aspects or embodiments, the imidazolium-based ionic liquid is of Formula I or IA, wherein Formula I is:

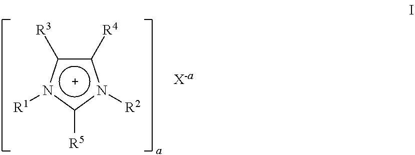

wherein
a is an oxidation state of X;
X is an anion selected from the group consisting of MeSO₄, OTf, BF₄, PF₆, Tf₂N, halide, dicyanamide, alkyl sulfonate and aromatic sulfonate;
each of R¹ and R² is independently alkyl, heteroalkyl, cycloalkyl, haloalkyl, silyl, siloxyl, aryl, alkenyl, or alkynyl; and
each of R³, R⁴, and R⁵ is independently hydrogen, alkyl, cycloalkyl, heteroalkyl, haloalkyl, silyl, siloxyl, aryl, alkenyl, or alkynyl; and

### Formula IA is:

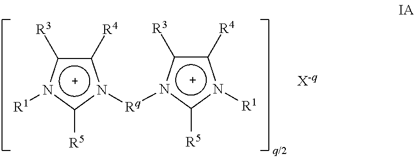

wherein
q is an oxidation state of X;
X is an anion selected from the group consisting of MeSO₄, OTf, BF₄, PF₆, Tf₂N, halide, dicyanamide, alkyl sulfonate and aromatic sulfonate;
each of R¹ and R² is independently alkyl, heteroalkyl, cycloalkyl, haloalkyl, silyl, siloxyl, aryl, alkenyl, or alkynyl;
each of R³, R⁴, and R⁵ is independently hydrogen, alkyl, cycloalkyl, heteroalkyl, haloalkyl, silyl, siloxyl, aryl, alkenyl, or alkynyl; and
R^{q} is alkylene, heteoralkylene, or haloalkylene.

Exemplary ionic liquids of the present application include but are not limited to 1-butyl-3-methylimidazolium hexafluorophosphate ([C₄mim][PF₆]), 1-butyl-3-methylimidazolium tetrafluoroborate ([C₄mim][BF₄]), 1-butyl-3-methylimidazolium bis[(trifluoromethyl)sulfonyl]imide ([C₄mim][Tf₂N]), 1,3-dimethylimidazolium methylsulfate ([C₁mim][MeSO₄]), 1-hexyl-3-methylimidazolium bis [(trifluoromethyl)sulfonyl]imide ([C₆mim][Tf₂N]), 1-ethyl-3-methylimidazolium trifluoromethanesulfonate ([C₂mim][OTf]), 1-ethyl-3-methylimidazolium dicyanamide ([C₂mim][dca]), 1-decyl-3-methylimidazolium trifluoromethanesulfonate ([C₁₀mim][Tf₂N]), 1-ethyl-3-methylimidazolium tetrafluoroborate ([C₂mim][BF₄]), 1-ethyl-3-methylimidazolium bis[(trifluoromethyl)sulfonyl]imide ([C₂mim][Tf₂N]), 1-butyl-3-methylimidazolium dicyanamide ([C₄mim][dca]), 1-ethyl-3-methylimidazolium mesylate ([C₂mim][OMs]) and 1-butyl-3-methylimidazolium trifluoromethanesulfonate ([C₄mim][OTf]). In one embodiment, the ionic liquid is selected from the group consisting of 1-hexyl-3-methylimidazolium bis[(trifluoromethyl)sulfonyl]-imide ([C₆mim][Tf₂N]), 1-butyl-3-methylimidazolium dicyanamide ([C₄mim][dca]), 1-ethyl-3-methylimidazolium trifluoromethanesulfonate ([C₂mim] [CF₃SO₃]), and 1-butyl-3-methylimidazolium trifluoromethanesulfonate ([C₄mim][OTf]).

In one embodiment, the amine compound of a composition disclosed herein is:

(a) a monoamine compound of Formula A:

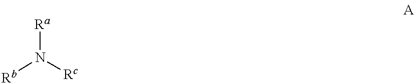

(b) a diamine compound of Formula B:

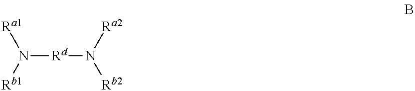

wherein
each of R^{a}, R^{a1}, R^{a2}, R^{b}, R^{b1}, and R^{b2} is independently hydrogen, alkyl, aryl, aralkyl, cycloalkyl, haloalkyl, heteroalkyl, alkenyl, alkynyl, silyl or siloxyl;
R^{c} is hydrogen, alkyl, aryl, aralkyl, cycloalkyl, haloalkyl, heteroalkyl, alkenyl, alkynyl, silyl, siloxyl, or a nitrogen protecting group; and
R^{d} is alkylene, aryl, aralkyl, cycloalkyl, haloalkyl, heteroalkyl, alkenyl, alkynyl, silyl or siloxyl;
   (c) a polyamine of Formula C:

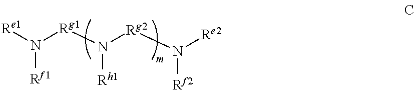

wherein
each of R^{e1}, R^{e2}, R^{f1}, R^{f2} and R^{h1} is independently selected from the group of hydrogen, alkyl, aryl, aralkyl, cycloalkyl, haloalkyl, heteroalkyl, alkenyl, alkynyl, silyl and siloxyl;
each of R^{g1} and R^{g2} is independently selected from the group of alkylene, arylene, aralkylene, cylcoalkylene, haloalkylene, heteroalkylene, alkenylene, alkynylene, silylene and siloxylene; and
m is 1, 2, 3, 4, or 5;
   (d) a linear poly(ethylene amine) of Formula D:

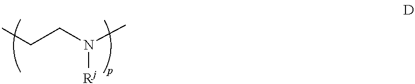

wherein
each R^{j} is independently selected from hydrogen, alkyl, aryl, aralkyl, cycloalkyl, haloalkyl, heteroalkyl, alkenyl, alkynyl, silyl and siloxyl; and
p is an integer between 1 and 1000;
   (e) a branched polyethylene amine of Formula E:

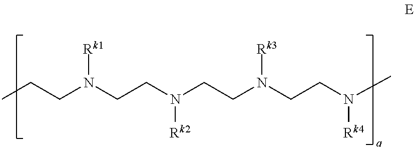

wherein
each of R^{k1}, R^{k2}, R^{k3}, and R^{k4} is independently selected from —R^{m1}—NRⁿ¹Rⁿ², —R^{m1}—NH(R^{m1}—NRⁿ¹Rⁿ²) and —R^{m1}—N(R^{m1}—NRⁿ¹Rⁿ²)₂;
   where R^{m1} is alkylene and each of Rⁿ¹ and Rⁿ² is independently selected from hydrogen and alkyl; and
q is an integer between 1 and 1000;
   (f) an amino acid;
   (g) a neutral N-heterocycle; or
   (h) a neutral N-heterocyclic-alkyl-amine.

In one variation, the amine compound is a monoamine of Formula A, a diamine of Formula B, a polyamine of Formula C, a linear polyethylene amine of Formula D, a branched polyethylene amine of Formula E, an amino acid, a neutral N-heterocycle, a neutral N-heterocyclic-alkyl-amine or a combination thereof.

One aspect of the present application is a composition comprising an ionic liquid and an amine compound, wherein the relative volume % of the ionic liquid compared to the total volume of the ionic liquid and the amine compound is about 60 vol % or less, wherein the ionic liquid comprises an anion selected from the group consisting of MeSO₄, OTf, BF₄, PF₆, Tf₂N, halide, dicyanamide, alkyl sulfonate and aromatic sulfonate and wherein the amine compound is a monoamine, a diamine, a polyamine, a polyethylene amine, an amino acid, a neutral N-heterocycle or a neutral N-heterocyclic-alkyl-amine.

In one embodiment of any of the disclosed aspects, the amine compound of a composition disclosed herein is a monoamine compound of Formula A:

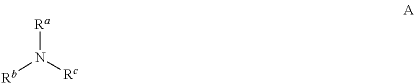

or a diamine compound of Formula B:

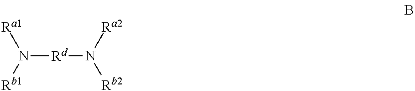

wherein
each of R^{a}, R^{a1}, R^{a2}, R^{b}, R^{b1} and R^{b2} is independently hydrogen, alkyl, aryl, aralkyl, cycloalkyl, haloalkyl, heteroalkyl, alkenyl, alkynyl, silyl or siloxyl;
R^{c} is hydrogen, alkyl, aryl, aralkyl, cycloalkyl, haloalkyl, heteroalkyl, alkenyl, alkynyl, silyl, siloxyl, or a nitrogen protecting group; and
R^{d} is alkylene, aryl, aralkyl, cycloalkyl, haloalkyl, heteroalkyl, alkenyl, alkynyl, silyl or siloxyl.

One variation is a composition comprising (a) a monoamine compound of Formula A or a diamine compound of Formula B and (b) an imidazolium-based RTIL or an ionic liquid of Formula I or Formula IA wherein X is selected from the group consisting of MeSO₄, OTf, BF₄, PF₆, Tf₂N, halide, dicyanamide, alkyl sulfonate and aromatic sulfonate.

In one embodiment the amine compound is a heteroalkylamine compound; in another embodiment, the heteroalkylamine compound is an alkanolamine compound. In some instances, the monoamine compound is selected from the group consisting of mono(hydroxyalkyl)amine, di(hydroxyalkyl)amine, tri(hydroxyalkyl)amine, and a combination thereof. In some cases, the monoamine compound is monoethanolamine (MEA), diglycolamine (DGA), diethanolamine (DEA), diisopropanolamine (DIPA), triethanolamine (TEA), N-methyldiethanolamine (MDEA), 2-amino-2-methyl-1-propanol (AMP) or a combination thereof.

In one variation of any of the aspects or embodiments disclosed herein, a composition further comprises a second amine, wherein the second amine is selected from the group consisting of

(a) a polyamine of Formula C:

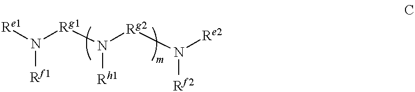

wherein
each of R^{e1}, R^{e2}, R^{f1}, R^{f2} and R^{h1} is independently selected from the group of hydrogen, alkyl, aryl, aralkyl, cycloalkyl, haloalkyl, heteroalkyl, alkenyl, alkynyl, silyl and siloxyl;
each of R^{g1} and R^{g2} is independently selected from the group of alkylene, arylene, aralkylene, cylcoalkylene, haloalkylene, heteroalkylene, alkenylene, alkynylene, silylene and siloxylene; and
m is 1, 2, 3, 4, or 5;
   (b) a linear poly(ethylene amine) of Formula D:

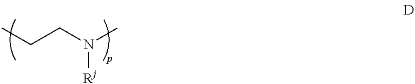

wherein
each R^{j} is independently selected from hydrogen, alkyl, aryl, aralkyl, cycloalkyl, haloalkyl, heteroalkyl, alkenyl, alkynyl, silyl and siloxyl; and
p is an integer between 1 and 1000;
   (c) a branched polyethylene amine of Formula E:

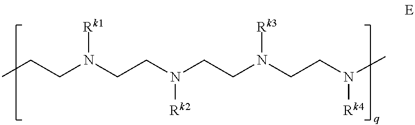

wherein
each of R^{k1}, R^{k2}, R^{k3}, and R^{k4} is independently selected from —R^{m1}—NRⁿ¹Rⁿ², —R^{m1}—NH(R^{m1}—NRⁿ¹Rⁿ²) and —R^{m1}—N(R^{m1}—NRⁿ¹Rⁿ²)₂;
   where R^{m1} is alkylene and each of Rⁿ¹ and Rⁿ² is independently selected from hydrogen and alkyl; and
q is an integer between 1 and 1000;
   (d) an amino acid;
   (e) a neutral N-heterocycle; and
   (f) a neutral N-heterocyclic-alkyl-amine.

In some embodiments, the impurity removing mixture further comprises a solvent. The solvent can be one or more of different ionic liquids, an organic solvent, water, or a mixture thereof. Typically, the solvent is an organic solvent. Exemplary organic solvents that can be used with compositions and methods disclosed herein include, but are not limited to, methanol, ethanol, propanol, glycols, acetonitrile, dimethyl sulfoxide, sulfolane, dimethylformamide, acetone, dichloromethane, chloroform, tetrahydrofuran, ethyl actetate, 2-butanone, toluene, as well as other organic solvents known to one skilled in the art.

In some embodiments, the amine compound of a composition of the present application is a heteroalkylamine compound. In some instances, the amine compound is an alkanolamine compound. Typically, an alkanolamine compound comprises a primary amine group. In other instances, the alkanolamine compound comprises a primary hydroxyl group. Typically, the alkanolamine compound comprises C₂-C₁₀ alkyl chain and often C₂-C₆ alkyl chain. However, it should be appreciated the length of the alkyl chain is not limited to these specific ranges and examples given herein. The length of the alkyl chain can vary in order to achieve a particular property desired.

Still in other embodiments, the amine compound is a monoamine compound. In some instances within these embodiments, the monoamine compound is of Formula A:

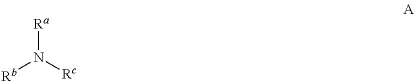

where
each of R^{a} and R^{b} is independently hydrogen, alkyl, aryl, aralkyl, cycloalkyl, (cycloalkyl)alkyl, haloalkyl, heteroalkyl, alkenyl, alkynyl, silyl or siloxyl; and
R^{c} is hydrogen, alkyl, aryl, aralkyl, cycloalkyl, (cycloalkyl)alkyl, haloalkyl, heteroalkyl, alkenyl, alkynyl, silyl, siloxyl, or a nitrogen protecting group.

Typically, each of R^{a} and R^{b} is independently hydrogen, alkyl, or heteroalkyl; and R^{c} is hydrogen, alkyl, or heteroalkyl. Often the heteroalkyl is hydroxyalkyl; often the heteroalkyl is hydroxyalkyl. Exemplary hydroxyalkyls include, but are not limited to, 2-hydroxyethyl, 3-hydroxypropyl, 2-hydroxypropyl, 4-hydroxybutyl, 3-hydroxybutyl, 2-hydroxybutyl, and the like. In some particular embodiments, the monoamine compound is selected from the group consisting of mono(hydroxyalkyl)amine, di(hydroxyalkyl)amine, tri(hydroxyalkyl)amine, and a combination thereof. Within these particular embodiments, in some cases the monoamine compound is monoethanolamine, diethanolamine, triethanolamine, or a combination thereof. It should be appreciated, however, the compositions disclosed herein are not limited to these particular monoamine compounds and examples given herein. The scope of the present application includes other monoamine compound in order to achieve a particular property desired.

Yet in other embodiments, the amine compound is a diamine compound. In some instances within these embodiments, the diamine compound is of Formula B:

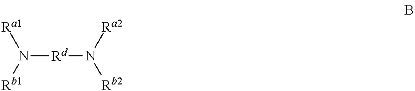

where
each of R^{a1}, R^{a2}, R^{b1}, and R^{b2} is independently hydrogen, alkyl, aryl, aralkyl, cycloalkyl, (cycloalkyl)alkyl, haloalkyl, heteroalkyl, alkenyl, alkynyl, silyl or siloxyl;
R^{c} is hydrogen, alkyl, aryl, aralkyl, cycloalkyl, (cycloalkyl)alkyl, haloalkyl, heteroalkyl, alkenyl, alkynyl, silyl, siloxyl, or a nitrogen protecting group; and
R^{d} is alkylene, arylene, aralkylene, cycloalkylene, haloalkylene, heteroalkylene, alkenylene, alkynylene, silylene or siloxylene.

Typically, each of R^{a1}, R^{a2}, R^{b1}, and R^{b2} is independently hydrogen, alkyl, or heteroalkyl; and R^{c} is hydrogen, alkyl, or heteroalkyl. Often the heteroalkyl is hydroxyalkyl. Exemplary hydroxyalkyls include, but are not limited to, 2-hydroxyethyl, 3-hydroxypropyl, 2-hydroxypropyl, 4-hydroxybutyl, 3-hydroxybutyl, 2-hydroxybutyl, and the like. R^{d} is generally alkylene, typically C₂-C₁₀ alkylene, and often C₂-C₆ alkylene. Exemplary alkylenes include, but are not limited to, ethylene, propylene, butylenes, pentylene, hexylene, 2-methylethylene, 2-methylbutylene, 2-ethylpropylene, and the like. It should be appreciated, however, the compositions disclosed herein are not limited to these particular diamine compounds and examples given herein. The scope of the present application includes a composition comprising other diamine compounds in order to achieve a particular property desired.

In other embodiments, the amine compound is an alkyl amine compound including, monoalkyl-, dialkyl-, and trialkylamine compounds. Typically each alkyl group within the alkyl amine compound is independently C₁-C₁₀ alkyl group. Often each alkyl group is independently C₁-C₆ alkyl group, and more often each alkyl group is independently C₁-C₃ alkyl group.

In some embodiments the amine compound of the compositions disclosed herein is a heteroalkylamine compound; in other embodiments, the heteroalkylamine compound is an alkanolamine compound. In some particular instances, the amine compound is a monoamine, wherein the monoamine compound is selected from the group consisting of mono(hydroxyalkyl)amine, di(hydroxyalkyl)amine, tri(hydroxyalkyl)amine, and a combination thereof. In some particular cases, the monoamine compound is monoethanolamine (MEA), diglycolamine (DGA), diethanolamine (DEA), diisopropanolamine (DIPA), triethanolamine (TEA), N-methyldiethanolamine (MDEA), 2-amino-2-methyl-1-propanol (AMP) or a combination thereof. In another embodiment, the amine compound is N-methyldiethanolamine, monethanolamine, 2-amino-2-methyl-1-propanol, diglycolamine, diethanolamine or combinations thereof.

In other embodiments, the amine compound is a polyamine having more than two amine functionalities, such as compounds of Formula C:

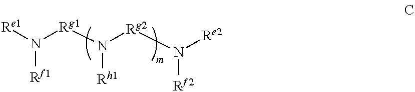

where each of R^{e1}, R^{e2}, R^{f1}, R^{f2} and R^{h1} is independently selected from the group of hydrogen, alkyl, aryl, aralkyl, cycloalkyl, haloalkyl, heteroalkyl, alkenyl, alkynyl, silyl and siloxyl;

each of R^{g1} and R^{g2} is independently selected from the group of alkylene, arylene, aralkylene, cylcoalkylene, haloalkylene, heteroalkylene, alkenylene, alkynylene, silylene and siloxylene; and

m is 1, 2, 3, 4, or 5.

Such polyamines are exemplified by, but not limited to, diethylenetriamine, spermidine, triethylenetetramine and spermine.

In still other embodiments, the polyamine is a linear polyethylene amine of

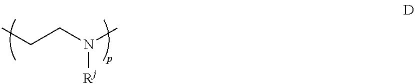

### Formula D:

where each R^{j} is independently selected from hydrogen, alkyl, aryl, aralkyl, cycloalkyl, haloalkyl, heteroalkyl, alkenyl, alkynyl, silyl and siloxyl; and
p is an integer between 1 and 1000.

Generally each R^{j} is independently selected from hydrogen and alkyl, alternately each R^{j} is independently selected from hydrogen and C₁C₄ alkyl. Typically the polyethylene amine is (CH₂CH₂NH)ₚ. Usually p is an integer between 1 and 750; or an integer between 1 and 500 or an integer between 1 and 250 or an integer between 1 and 100. Alternately p is an integer between 1 and 50; an integer between 2 and 25 or even an integer between 5 and 10.

Alternately, the polyamine is a branched polyethylene amine of Formula E:

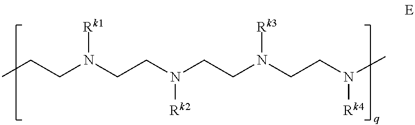

wherein each of R^{k1}, R^{k2}, R^{k3}, and R^{k4} is independently selected from —R^{m1}—NRⁿ¹Rⁿ², —R^{m1}—NH(R^{m1}—NRⁿ¹ Rⁿ²) and —R^{m1}—N(R^{m1}—NRⁿ¹Rⁿ²)₂;
   where R^{m1} is alkylene and each of Rⁿ¹ and Rⁿ² is independently selected from hydrogen and alkyl; and
q is an integer between 1 and 1000.

Generally R^{m1} is a C₁-C₈ alkylene, alternately a C₁-C₆ alkylene or a C₂-C₄ alkylene. Typically, Rⁿ¹ and Rⁿ² each independently is selected from hydrogen and C₁-C₈ alkyl, alternately hydrogen and C₁-C₆ alkyl or C₂-C₄ alkyl. Usually, p is an integer between 1 and 750; or an integer between 1 and 500 or an integer between 1 and 250 or an integer between 1 and 100. Alternately p is an integer between 1 and 50; an integer between 2 and 25 or even an integer between 5 and 10.

Without being bound by theory it is believed that the multiple amine functionalities per molecule of a polyamine provide more CO₂ ‘capture’ sites. Polyamines are generally much less volatile than other amines and in certain examples are completely non-volatile.

In still a further embodiment, the amine compound is an amino acid. In both natural and non-standard amino acids, either the zwitterion or a salt form can be employed. The amine sites within amino acids and amino acid salts are useful in a composition disclosed herein because amino acids and their salts are largely non-volatile. Generally it is believed that CO₂ can react directly with the amine moiety of the amino acid salt. In combination with RTIL-amine solvents (for example an RTIL with monoethanolamine), the presence of amino acids and/or amino acid salts can also promote CO₂ absorption and reduce corrosion.

In an additional embodiment, the amine compound is a neutral nitrogen-containing heterocyclic compound, i.e. a neutral N-heterocycle. Neutral N-heterocycles can also promote CO₂ absorption and reduce corrosion. They can be more or less volatile than other amines, such as MEA. Compounds such as piperazine (PZ) act analogously to secondary amines for CO₂ capture, while aromatics such as imidazole or pyridine or derivatives thereof may act similarly to tertiary amines or as proton acceptors when used in combination with primary and/or secondary amines in the capture of an impurity such as CO₂. In one variation such neutral N-heterocycles are bound to a pendant amine via an alkylene linker. Such neutral N-heterocyclic-alkyl-amines include, but are not limited to:

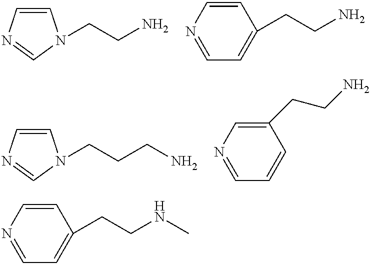

Without being bound by theory, it is believed that these molecules capture CO₂ in the following manner:

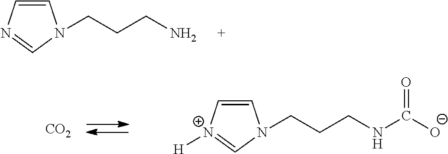

In the above example, one molecule of CO₂ is captured per molecule of heterocycle. Neutral heterocycles bearing pendant amine groups are less volatile than other amines and can also reduce corrosion and promote CO₂ absorption.

It is further contemplated that zwitterionic salts comprising an imidazole component bound to a pendant sulfate moiety, as known to those of skill in the art and

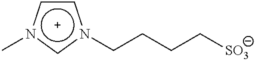

exemplified by:

can be included in a composition of the present application. Zwitterionic salts can promote CO₂ absorption or act as proton shuttles in the capture of CO₂ during the formation of carbamate salts. They may also reduce corrosion.

It is additionally contemplated that a neutral heterocycle bound to a pendant anion can be a component of a composition disclosed herein; such salts are well-known to

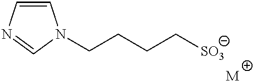

those of skill in the art and are exemplified by:

Without being bound by theory, it is believed that such salts promote CO₂ absorption; it is further believed that the nitrogen atoms within the ring act as a proton acceptor.

One aspect of the present application is a composition comprising an ionic liquid and a heteroalkylamine compound wherein the ionic liquid comprises an anion selected from the group consisting of MeSO₄, OTf, BF₄, PF₆, Tf₂N, halide, dicyanamide, tricyanomethane, alkyl sulfonate and aromatic sulfonate. In one embodiment, a composition comprises an ionic liquid of Formula I:

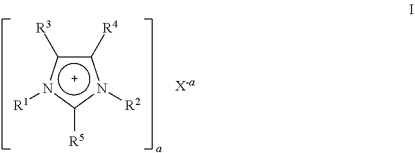

wherein
a is an oxidation state of X;
X is an anion selected from the group consisting of MeSO₄, OTf, BF₄, PF₆, Tf₂N, halide, dicyanamide, alkyl sulfonate and aromatic sulfonate;
each of R¹ and R² is independently alkyl, heteroalkyl, cycloalkyl, haloalkyl, silyl, siloxyl, aryl, alkenyl, or alkynyl;
each of R³, R⁴, and R⁵ is independently hydrogen, alkyl, cycloalkyl, heteroalkyl, haloalkyl, silyl, siloxyl, aryl, alkenyl, or alkynyl.
   In one variation, the heteroalkylamine is an alkanolamine. In another variation the heteroalkylamine comprises monoethanolamine, diglycolamine, diethanolamine, diisopropanolamine, triethanolamine, methyldiethanolamine, 2-amino-2-methyl-1-propanol or a combination thereof.

One embodiment of the present application is a composition wherein the ionic liquid comprises [C₆mim][Tf₂N] and the heteroalkylamine comprises N-methyldiethanolamine; in another embodiment the ionic liquid comprises [C₆mim][Tf₂N] and the heteroalkylamine comprises N-methyldiethanolamine and monethanolamine; in yet another embodiment the ionic liquid comprises [C₄mim][dca] and the heteroalkylamine comprises N-methyldiethanolamine and 2-amino-2-methyl-1-propanol; in still a further embodiment the ionic liquid comprises [C₄mim][OTf] and the heteroalkylamine comprises diglycolamine and diethanolamine; in another embodiment the ionic liquid comprises [C₂mim][OTf] and the heteroalkylamine comprises diglycolamine and diethanolamine; in an alternate embodiment the ionic liquid comprises [C₄mim][dca] and the heteroalkylamine comprises monethanolamine.

The relative amount of ionic liquid compared to the total amount of ionic liquid and the amine compound can vary widely. It should be appreciated that in general, the impurity or the undesired compound that one wishes to remove from a source forms a complex or an addition product with the amine compound or becomes solubilized in the composition, accordingly the higher amount of an amine compound in a composition disclosed herein provides a higher amount of the complex or an addition product formation. Without being bound by any theory, it is believed that typically an impurity forms a complex or an addition product with an amine compound. In some instances, it is believed that the ionic liquid solubilizes the impurity. In some embodiments, the complex or the addition product forms a precipitate. Typically when the amine compound is an alkylamine compound, the relative amount of the ionic liquid compound compared to the total amount of the ionic liquid and the amine compound is about 85 vol % or less, often about 60 vol % or less, and more often about 50 vol % or less. In one variation of any of the disclosed aspects, a composition comprises between about 20 vol % and about 70 vol % RTIL; in another variation, a composition comprises between about 30 vol % and about 60 vol % RTIL; in yet another variation, a composition comprises about 50 vol % RTIL. In another variation, a composition comprises between about 30 vol % and about 80 vol % of a single amine or a combination of amines; in another variation, a composition comprises between about 40 vol % and about 70 vol % of a single amine or a combination of amines. In yet another variation, a composition comprises about 50 vol % of a single amine or a combination of amines. In a variation where more than one amine is present, the two or more amines can be present in the same volume percent (vol %), such as each at about 25 vol % (when the volume % of the amine is about 50 vol %), or the amines can present in different volume percents, such as one at about 40 vol % and the other at 30 vol % (when the volume % of the amine is about 70 vol %).

Alternatively, the relative amount of the ionic liquid compound compared to the total amount of the ionic liquid and the amine compound is about 85 wt % or less, often about 70 wt % or less, more often about 60 wt % or less, and still more often about 50 wt % or less. It should be appreciated, however, the relative amount of the ionic liquid compared to the total amount of the ionic compound and the amine compound is not limited to these particular ranges and examples given herein. The scope of the present application includes any relative amount of the ionic liquid compared to the total amount of the ionic compound and the amine compound as long as the composition can be used to remove impurities or undesired material from a source.

In one embodiment, a composition of the present application comprises about 60 vol % [C₆mim][Tf₂N] and about 40 vol % N-methyldiethanolamine; in another embodiment, a composition comprises about 30 vol % [C₆mim][Tf₂N], about 40 vol % N-methyldiethanolamine and about 30 vol % monethanolamine. In yet another embodiment, a composition comprises about 30 vol % [C₄mim][dca], about 40 vol % N methyldiethanol-amine and about 30 vol % 2-amino-2-methyl-1-propanol; in still another embodiment, a composition comprises about 50 vol % [C₄mim][OTf], about 25 vol % diglycolamine and about 25 vol % diethanolamine. In yet another embodiment a composition comprises about 50 vol % [C₂mim][OTf], about 25 vol % diglycolamine and about 25 vol % diethanolamine; in another embodiment, a composition comprises about 60%[C₄mim][dca] and about 40% monethanolamine.

When the amine compound is an alkanolamine compound, the relative amount of the ionic liquid compound compared to the total amount of the ionic liquid and the amine compound can be any amount as long as the composition can be used to remove an impurity or undesired material from a source. However, as stated herein, when a composition is used to remove or separate one or more impurities and/or undesired materials from a source, an amine compound typically forms a complex or an addition product (“complex product” or “addition product”, respectively) with such impurities and/or undesired materials. Thus, in general the higher amount of an amine compound in a composition provides a higher amount of impurities and/or undesired materials that may be removed from a source.

Still further, combinations of various groups described herein form other embodiments. For example, in one particular embodiment of an imidazolium-based IL of Formula I, R¹ is alkyl, a is 1, R² is hydroxyalkyl, and R³, R⁴, and R⁵ are hydrogen. In this manner, a variety of compounds and compositions are embodied and disclosed within the present application.

### Utility

Descriptions of well known processing techniques, components, and equipment are omitted so as not to unnecessarily obscure the methods and devices in unnecessary detail. The descriptions of the methods and devices disclosed herein are exemplary and non-limiting. Certain substitutions, modifications, additions and/or rearrangements falling within the scope of the claims, but not explicitly listed in this disclosure, will become apparent to those of ordinary skill in the art based on this disclosure.

Each of the compositions disclosed herein can be used in a wide variety of application including use as catalytic systems in various reactions, extraction media, cleaning composition, as well as other applications for ionic liquids that are known to one skilled in the art.

One aspect of the present application is a method for reducing the amount of an impurity gas in a fluid stream, the method comprising contacting the fluid stream with an impurity removing mixture comprising an ionic liquid disclosed herein and an amine compound disclosed herein under conditions sufficient to reduce the amount of impurity gas from the fluid stream.

Another aspect of the present application is a method for reducing the amount of an impurity gas in a fluid stream, the method comprising contacting the fluid stream with an impurity removing mixture comprising: an ionic liquid; and an amine compound, under conditions sufficient to reduce the amount of impurity gas from the fluid stream;

wherein the ionic liquid comprises a non-carboxylate anion; and wherein the amine compound is a monoamine, a diamine, a polyamine, a polyethylene amine, an amino acid, a neutral N-heterocycle or a neutral N-heterocyclic-alkyl-amine.

Yet another aspect of the present application is a method for removing an impurity from a solid substrate surface to produce a clean solid substrate surface, the method comprising: contacting the solid substrate surface with an impurity removing mixture comprising an ionic liquid disclosed herein and an amine compound disclosed herein under conditions sufficient to remove the impurity from the solid substrate surface to produce a clean solid substrate surface.

In one embodiment of any disclosed aspect, the ionic liquid comprises a non-carboxylate anion and the amine compound is a monoamine, a diamine, a polyamine, a polyethylene amine, an amino acid, a neutral N-heterocycle; or a neutral N-heterocyclic-alkyl-amine. In one variation, the amine compound is a monoamine of Formula A or a diamine of Formula B and the ionic liquid comprises MeSO₄, OTf, BF₄, PF₆, Tf₂N, halide, dicyanamide, alkyl sulfonate or aromatic sulfonate. In one embodiment, the solid substrate comprises a semi-conductor.

When the source is a fluid medium, e.g., a gas or a liquid, a composition disclosed herein can be used according to a disclosed method to remove, separate or extract one or more impurities and/or undesired materials from a source. For example, disclosed herein is a method to use a composition of the present application to remove an undesired gas such as CO₂, CO, COS, CS₂, H₂S, SO₂, NO, N₂O, a mercaptan (e.g., an alkylmercaptan), H₂O, O₂, H₂, N₂, methane, propane, a relatively short chain hydrocarbon, such as C₁-C₈ hydrocarbon and/or a volatile organic compound.

In one embodiment, the impurity comprises CO₂, CO, COS, CS₂, H₂S, SO₂, NO, N₂O, H₂O, O₂, H₂, N₂, a volatile organic compound, and a combination thereof. Alternately, the impurity comprises CO₂, CO, COS, CS₂, H₂S, SO₂, NO, N₂O, an alkylmercaptan, H₂O, O₂, H₂, N₂, a C₁-C₈ hydrocarbon or a combination thereof. In one embodiment, the undesired gas comprises CO₂, H₂S, CO, COS, CS₂, NO, or N₂O. Alternately, the impurity gas comprises CO₂, H₂S, SO₂, or a combination thereof; in another embodiment, the undesired gas comprises CO₂. In some instances, the undesired material comprises an organothiol compound, a hydrocarbon, or a mixture thereof.

In one embodiment, at least about 60% of the impurity is removed via contact with an impurity removing composition disclosed herein. In another embodiment, at least about 75% of the impurity is removed; alternately, at least about 90% of the impurity is removed. In some examples, up to 99% of the impurity is removed from a source such as a fluid medium, e.g. a flue gas or oil, or from a solid substrate surface via contact with the impurity removing compositions disclosed herein.

In some embodiments, the disclosed compositions are used in the methods of the present application under pressure. Such increased pressure can increase the rate of complex and/or addition product formation between an amine compound and an impurity in a source. In one embodiment, the step of contacting a fluid medium with an impurity removing mixture is conducted under pressure, e.g., greater than 1 atm. When a fluid medium is contacted with an impurity removing mixture under pressure, typically a pressure of at least about 6 atm is used, often at least about 8 atm, and more often at least about 10 atm.

In one embodiment of any of the aspects disclosed herein, a fluid medium comprises a hydrocarbon source. Often a hydrocarbon source comprises natural gas, oil, or a combination thereof. Still in other embodiments, the step of contacting a fluid medium with an impurity removing mixture produces an addition product or a complex between an impurity and an amine compound.

Typically, different gases have different solubilities depending on the nature of ionic liquids. In some instances, two or more ionic liquids in combination provides higher solubility to an undesired gas. Accordingly, the scope of the present disclosure includes compositions having a mixture of two or more different ionic liquids.

Without being bound by any theory, it is believed that the ionic liquid solubilizes an impurity and an amine compound forms a complex and/or an addition product with an impurity. Accordingly, it is believed that both the ionic liquid and the amine compound, examples of which are disclosed herein, are responsible for effectively removing impurities. Thus, the selection of the amine compound and the ionic liquid is believed to be important in removing the impurities. Typically, the compositions disclosed herein are miscible; that is, the amine compound and the ionic liquid do not form a separate layer but form a single miscible layer. In some instances, a solvent, examples of which are disclosed herein and others known to one of skill in the art, can be added to an impurity removing mixture to increase the miscibility of an amine compound and an ionic liquid. Typically, an amine compound is also reactive with or is capable of relatively readily forming a complex with an impurity. Generally an alkyl amine compound or a heteroalkyl amine compound, in particular an alkanolamine compound, is used in the compositions and methods disclosed herein due to high reactivity with impurities as well as cost considerations.

In some embodiments, a method for removing an impurity as disclosed herein include pressurizing the admixture of a composition disclosed herein (an impurity removing mixture) and a source to be purified. It is believed that subjecting such an admixture to pressurized conditions (i.e., greater than the standard pressure which is 1 atm) increases the rate of complex and/or addition product formation between the impurity and an amine compound. When pressurizing conditions are used, typically a pressure of greater than 1 atm, more often at least 2 atm, and still more often at least 5 atm is used. Sometimes pressure of at least about 10 atm is used.

As discussed above, compositions disclosed herein can be used to remove an impurity from a wide variety of sources including, but not limited to, a solid such as a semi-conductor and other electronic device, a fluid such as natural gas, waste emission, oil, a gas evolved from biological sources, respiratory gases, combustion products, decomposition products, chemical reactions, gases released as a result of depressurization, or any other fluid medium sources in which a removal or separation of undesired gases is desired. Generally the methods disclosed herein are used for the purification of a fluid, such as natural gas, oil, or a combination thereof. Alternately, the methods disclosed herein are used for the purification of a solid surface substrate, such as a semi-conductor.

For the sake of clarity and brevity, methods herein are described with respect to reducing a gas impurity from a fluid medium. However, it should be appreciated that one skilled in the art having read the present disclosure can readily adopt compositions and methods disclosed herein for removing other impurities from various sources.

The methods of the present application comprising use of a composition disclosed herein can optionally include use of a solvent, such as water, an organic solvent, or a combination thereof. Exemplary organic solvents that are suitable in methods disclosed herein include, but are not limited to, chloroform, dichloromethane, methanol, ethanol, propanol, glycols, acetonitrile, dimethyl sulfoxide, sulfolane, dimethylformamide, acetone, tetrahydrofuran, ethyl acetate, 2-butanone, toluene and other organic solvents known to one skilled in the art.

RTILs have a number of properties that make them useful in gas separations. For example, RTILs are generally non-volatile, largely inflammable, and have good gas (e.g., CO₂) solubility and CO₂/N₂ and CO₂/CH₄ separation selectivity. The dissolution of CO₂ (and other gases) in RTILs (and other solvents) is believed to be a physical phenomenon, with no appreciable chemical reaction occurring unlike with amine solutions that are often used in other methods.

Amine-functionalized RTILs (those containing amine groups chemically tethered to the anion and/or cation) are not feasible for use in a large industrial setting or in smaller-scale CO₂ capture devices, such as those on submarines. The use of these amine-functionalized RTILs as neat (without a co-solvent) solvents for CO₂ capture is an ill-conceived notion. The viscosity of amine-functionalized RTILs used in CO₂ capture is quite high, thereby limiting its implementation in large scale scrubbing applications. Furthermore, amine-functionalized RTILs no longer resemble a liquid upon capture of CO₂, but instead often form an intractable tar.

The present inventors have discovered a cheaper and more attractive method to combine an amine compound and an ionic liquid without the use of covalent linkages. Such combination avoids formation of intractable tar, which is often the case with an amine tethered RTILs. Inexpensive, commercially used amines, such as monoethanolamine (MEA) or diethanolamine (DEA), can be readily dissolved in ILs. Additional amine compounds that are possible components of the impurity removing mixture are disclosed herein. These amine-IL solutions can be used effectively for the capture of various impurities or gases including, but not limited to, CO₂, CO, COS, CS₂, H₂S, SO₂, NO, N₂O, an alkyl mercaptan, H₂O, O₂, H₂, N₂, methane, propane, another relatively short chain hydrocarbon, and/or a volatile organic compound. Generally an impurity comprises CO₂, CO, COS, H₂S, SO₂, methane, propane or a combination thereof,

Currently, various aqueous amine solutions are used in various industries to remove CO₂ and/or H₂S. Compositions disclosed herein offer advantages over their aqueous counterparts, for example, a lower energy usage per volume of CO₂ captured. Furthermore, the volume of fluid needed to process the captured CO₂ and the ability to tune the IL to enhance the rate of CO₂ uptake makes compositions comprising an IL and an amine compound as disclosed herein very attractive as a gas capture media.

The removal of CO₂, H₂S, and other gases from natural gas (e.g., CH₄) and air (including recirculated air) is important to industry, society and the environment. Currently, the separation of CO₂ from other gases is accomplished through its contacting and subsequent reaction with an aqueous amine solution. Typical and widely used water-soluble amine compounds and the pressure of CO₂ at which they are generally effective are shown below:

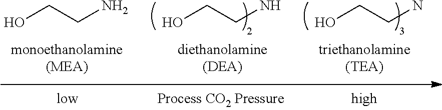

The reaction mechanisms for forming a carbamate salt with MEA is illustrated below:

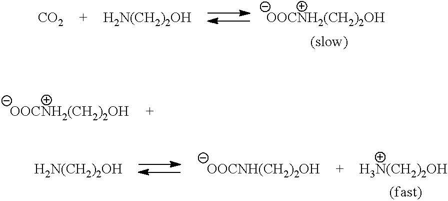

Without being bound by any theory, it is believed that the rate-limiting step of the formation of the zwitterion is maintained by the proton transfer reaction to form a carbamate. The CO₂-adduct remains in solution unless the solution is heated, the partial pressure is reduced or a combination thereof. This process is effective for the separation of CO₂ from other gases on large and small scales.

The present inventors have found that compositions comprising a RTIL and an amine compound (“RTIL-amine solutions”, such as RTIL-MEA as disclosed herein) are effective in CO₂ capture. Such mixtures exhibit rapid and reversible CO₂ uptake, and are capable of capturing 1 mole of CO₂ per 2 moles of dissolved amine.

RTIL-amine compositions as disclosed herein offer many advantages over conventional aqueous amine solutions, especially in the energy required to process acid gases (e.g., CO₂). For example, imidazolium-based RTILs have less than one-third the heat capacity of water (e.g., 1.30 vs. 4.18 J g⁻¹ K⁻¹), or less than one-half on a volume basis (e.g., 1.88 vs. 4.18 J cm⁻³ K⁻¹). Decomplexation of CO₂ from aqueous carbamates requires heating the solution to elevated temperatures, after which water and some amine need to be condensed or replaced. Unlike water, RTILs do not evaporate so that there is no energy loss associated with evaporation during amine regeneration. While alkanolamines have relatively low vapor pressures, it is believed that their volatility is further suppressed due to colligative properties in RTIL solutions, minimizing amine losses from the compositions of the present application when used according to a method disclosed herein. Furthermore, unlike other solvents, both the solubility and selectivity of CO₂ (or any other undesired material) in RTILs can be readily “tuned” by tailoring the structures of the cation and/or anion, or by using one or more additional amine compounds to promote miscibility.

In aqueous solutions, MEA is generally the most commonly used amine compound for low partial pressure acid gas applications. MEA is miscible with both [C₆mim] [Tf₂N] and [C₂OHmim] [Tf₂N], whose structures are given below, respectively:

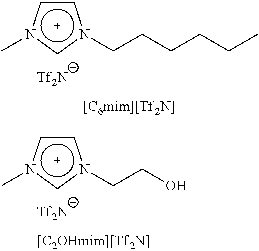

but the corresponding CO₂ adduct, i.e., carbamate shown below:

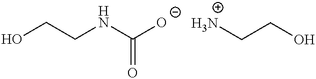

is not soluble in either [C₆mim] [Tf₂N] or [C₂OHmim] [Tf₂N]. It should also be noted that some amine compounds that are useful for CO₂ capture are not necessarily soluble in every RTIL. For example, DEA was found to be immiscible with RTILs containing solely alkyl substituents (i.e., [C₆mim][Tf₂N]). To expand RTIL-amine solutions to include solubilized 2° alkanolamines, an RTIL containing a tethered 1° alcohol (e.g., [C₂OHmim][Tf₂N]) was used, which was miscible with MEA and DEA. The ability to tune the solubility and compatibility properties of RTILs is a powerful tool for process optimization, and allows for these solutions to be used for CO₂ capture at a range of pressures. These broad capabilities of RTIL-amine solutions are not easily obtainable with a “task-specific” ionic liquid (TSIL, i.e., an “amine-tethered RTILs”).

Generally, at low pressure, a secondary amine has CO₂ loading levels higher than a tertiary amine but generally lower than a primary amine. A secondary amine also has a lower regeneration energy than a primary amine. Secondary amines, such as diethanolamine (DEA), are typically less volatile than primary or tertiary amines.

As the CO₂ adduct carbamate is not generally soluble in the RTIL-amine solutions disclosed herein, the reaction equilibrium is shifted to further favor formation of the carbamate, making it possible to remove even small amounts of CO₂ and H₂S from very dilute gas mixtures using the presently disclosed compositions. The MEA-based carbamate is not soluble in either [C₆mim] [Tf₂N] or [C₂OHmim] [Tf₂N], thereby reducing the concentration of the carbamate in solution. By reducing the carbamate concentration in solution, the residual CO₂ content in the source gas can be brought to very low levels by shifting the proton transfer reaction to the right towards product formation. The solubility of the carbamate in the RTIL-amine solutions disclosed herein is in sharp contrast to the behavior of these salts in aqueous (or polar organic) solutions. For example, carbamate salts of MEA are highly soluble in water.

As discussed above, the amine compound forms a carbamate with CO₂, and so the methods disclosed herein can also be used in synthesis of carbamates or other addition products between an amine compound and a compound comprising a complementary functional group that is reactive with the amine functional group. Alternatively, by using other functionalized compounds in place of an amine compound, one can achieve synthesis of a wide variety of compounds.

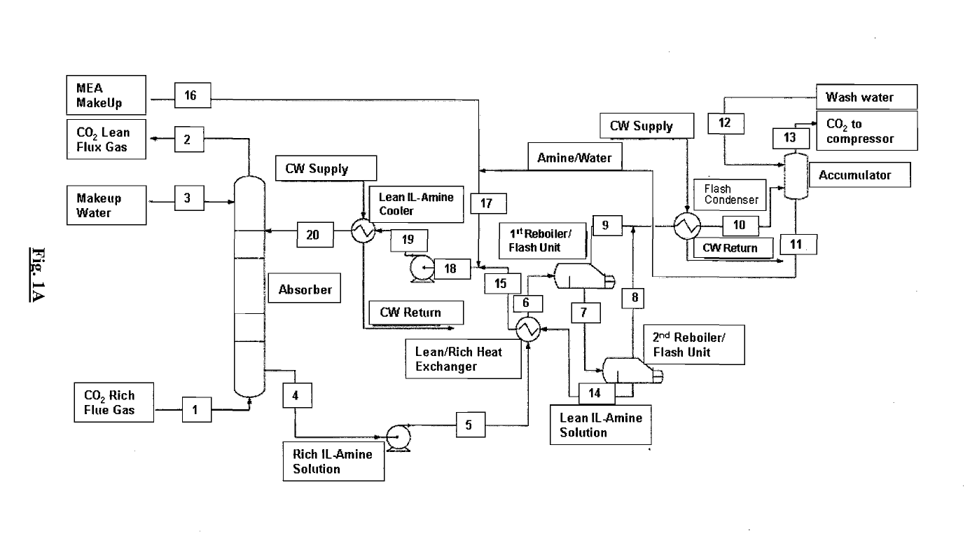

FIG. 1 is a schematic representation of a typical aqueous amine gas treatment unit, known to those of skill in the art. RTILs can be utilized in several ways with minimal modifications to an aqueous amine gas treatment unit. One straight-forward method is to replace the solvent (water) identified in FIG. 1 with a composition disclosed herein. Typically, e.g. in the purification of natural gas, the absorber of FIG. 1 operates between about 35° C. and about 50° C. and between about 5 atm and about 205 atm of absolute pressure; the regenerator generally operates between about 115° C. and about 126° C. and between about 1.4 atm and about 1.7 atm of absolute pressure, when measured at the bottom of the tower. In the purification of flue gas, the regenerator generally operates between about 120° C. and about 150° C. The pressure of flue gas is generally about 1 to about 5 atm, typically closer to about 1 atm. Generally, a source containing an impurity enters the bottom of the absorber, which contains an impurity removing mixture as disclosed herein, comprising an ionic liquid and an amine compound. An impurity, often CO₂ and/or H₂S, is captured by the mixture. Purified source then exits the absorber.

The impurity rich solution is transferred to the regenerator-still column, where the captured impurity is released by heating or reducing the partial pressure in the regenerator-still column. As shown in FIG. 1, the acid-gas rich amine is heated in the regenerator-still column by heat supplied from a reboiler. The steam rising through the regenerator-still liberates CO₂ and/or H₂S, regenerating the amine. Steam and acid gases separated from the rich amine are condensed and cooled. The condensed water is separated in the reflux drum and returned to the regenerator-still. The regenerated impurity removing mixture (“lean solution”) is then fed back into the absorber.

Alternatively, one or more reboilers can be used to strip the acid gases (CO₂ and/or H₂S) out of the rich amine instead of, or in addition to, the regeneration-still column. As shown in FIG. 1A, the acid gas rich amine solution from the absorber flows through a heat exchanger, heating the rich amine. The acid-gas rich amine is then circulated to a first reboiler/flash unit where the amine is further heated and/or the pressure is reduced to partially release the captured acid gases. The amine solution then flows to a second reboiler/flash unit where it is heated and/or the pressure is reduced to remove additional acid gases from the amine solution. Steam and acid gases separated from the rich amine in the first and second reboiler/flash units are condensed and cooled. The condensed water is separated in the accumulator and returned to the absorber. Regenerated, lean amine from the first and second reboiler/flash units is then cooled and fed back into the absorber. In alternative embodiments, the amine regeneration system can have only one reboiler/flash unit, or can have multiple reboiler/flash units arranged in series or parallel to more efficiently remove acid gases from the rich amine solution. The reboiler/flash units can also be used with a regenerator-still as described above depending on the amount of acid gas to be removed from the amine solution. This flexibility provides the opportunity to use lower quality or waste steam in the amine regeneration process.

As known to one of skill in the art, the purification cycle can be repeated stepwise or in a continuous manner. Generally, use of an impurity removing composition disclosed herein recovers an impurity such as CO₂ in yields of at least about 60%, alternately at least about 70%. In some examples, an impurity is recovered in yield of at least about 90% or even at least about 99%.

Since many RTILs have approximately half the heat capacity of water on a volume basis and RTILs do not evaporate, there is an energy savings from the heating and cooling of the solution between the absorber and regenerator when an RTIL-amine solution is used as described herein, instead of the aqueous amine solutions currently employed. According to one estimate, for CO₂ capture at a coal-fired power plant the regenerator for an aqueous amine solvent would require about 3200 Btu/lb CO₂ while an ionic liquid-amine impurity removing composition disclosed herein generally requires about 985 Btu/lb CO₂. Furthermore, since RTILs have a very low vapor pressure there are no significant losses of the RTIL due to vaporization during the process. Losses of the amine (and a solvent if any is used) are also generally reduced compared to the aqueous system due to colligative properties whereby the amine/solvent vapor pressure is reduced due to the low vapor pressure of the RTIL.

Another benefit of the low vapor pressure of the RTIL is that if a sweep gas is needed (in typical aqueous amine solutions water vapor is the sweep gas) a more energy efficient method can be implemented. Generally the systems employing an IL-amine mixture described herein can operate without a sweep gas; without a sweep gas the regenerator can to be heated to a higher temperature. Water vapor can be used as the sweep gas with an IL-amine solution disclosed herein, but more often an organic vapor, such as hexane vapor, is used when a sweep gas is employed, as the organic vapor generally requires much less energy to condense.

Another way that RTILs can be used to improve energy efficiency compared to aqueous systems is due to the fact that while MEA is soluble in RTILs as disclosed herein, such as [C₆mim] [Tf₂N], the corresponding carbamate is not. This allows the separated carbamate to be regenerated without having the added energy consumption of heating a large volume of solvent to the temperature necessary to regenerate the amine. Generally the precipitated carbamate can be separated for direct regeneration (to amine compound and CO₂). The solubility of the carbamate formed in the purification process can be controlled by the choice of ionic liquid and/or amine compound. In systems where a precipitate is formed (where the carbamate is not soluble in the impurity removing mixture), the resulting slurry is pumped to the regenerator or the precipitate is separated from the solution via centrifugation or other methods known to those of skill in the art. When the ionic liquid-amine mixture is selected so that the carbamate is soluble, the impurity-rich liquid solution can be transferred to the regenerator as described above.

It should be appreciated that processes disclosed herein are not limited to the process shown in FIGS. 1 and 1A. One skilled in the art can readily modify, delete, and/or add various components and/or elements shown in FIGS. 1 and 1A. For example, the process can be a virtually a continuous process or it can be a stepwise process. Furthermore, the disclosed processes can also include a pre-mixing step where an amine compound and an ionic liquid are mixed prior to contacting the mixture with a fluid stream. Such a pre-mixing step can be achieved in a separate chamber or an amine compound and an ionic liquid can be injected into the extraction chamber simultaneously through separate inlets (or separately or stepwise through separate inlets or the same inlet) under turbulent conditions, e.g., jet stream, to provide mixing.

Historically, the captured CO₂ or other impurities have simply been vented to atmosphere. However, the generation of large amounts of CO₂ was of little or no concern until recently when the participation of carbon dioxide in the accumulation of greenhouse gases and the possible affect this may have on global warming was recognized. It has since become a concern of some urgency such that there exists a definite need to reduce the amount of carbon dioxide released to the atmosphere by combustion processes, coal and petroleum fired electric power plants, plants producing Portland cement, and natural gas and petroleum refining operations have been singled out as examples of process which release vast amounts of CO₂ per year.

Carbon capture and storage is the process of mitigating the contribution of fossil fuel emissions to global warming, based on capturing CO₂ from large point sources such as fossil fuel power plants or natural gas sweetening operations, and utilizing the captured CO₂ or otherwise storing it away from atmosphere by other techniques. CO₂ sequestration is the part of the process whereby the captured CO₂ is stored or otherwise disposed of using subsurface saline aquifers, reservoirs, ocean water, aging oil fields, or other carbon sinks. Although CO₂ has been injected into geological formations for various purposes, the long term storage of CO₂ is a relatively new concept.

Various forms have been conceived for permanent storage of CO₂. These forms include gaseous storage in various deep geological formations (including saline formations and exhausted gas fields), liquid storage in the ocean, and solid storage by reaction of CO₂ with metal oxides or metal hydroxides to produce stable carbonates.

Geo-sequestration involves injecting carbon dioxide, generally in supercritical form, directly into underground geological formations. Oil fields, gas fields, saline formations, unminable coal seams, and saline-filled basalt formations have been suggested as storage sites. Various physical (e.g., highly impermeable caprock) and geochemical trapping mechanisms would prevent the CO₂ from escaping to the surface.

CO₂ is sometimes injected into declining oil fields to increase oil recovery. The injection of CO₂ to produce oil is generally called Enhanced Oil Recovery (“EOR”). This option is attractive because the geology of hydrocarbon reservoirs are generally well understood and storage costs may be partly offset by the sale of additional oil that is recovered. Disadvantages of old oil fields are their geographic distribution and their limited capacity. For example, after capture, the CO₂ needs to be transported to suitable oil production fields. This is done by pipeline, which is generally the cheapest form of transport, there are a limited number of CO₂ pipelines in the United States and new pipelines can be expensive and difficult to build. Furthermore, when the oil is produced, the CO₂ re-released into the atmosphere.

Umninable coal seams can be used to store CO₂ because CO₂ adsorbs to the surface of coal. However, the technical feasibility depends on the permeability of the coal bed. In the process of absorption, the coal releases previously absorbed methane, and the methane can be recovered (enhanced coal bed methane recovery). The sale of the methane can be used to offset a portion of the cost of the CO₂ storage.

Saline formations contain highly mineralized brines, and have so far been considered of no benefit to humans. Saline aquifers have been used for storage of chemical waste in a few cases. The main advantage of saline aquifers is their large potential storage volume and their common occurrence. The major disadvantage of saline aquifers is that relatively little is known about them, compared to oil fields. To keep the cost of storage acceptable the geophysical exploration may be limited, resulting in larger uncertainty about the aquifer structure. Unlike storage in oil fields or coal beds no side product will offset the storage cost. Leakage of CO₂ back into the atmosphere may be a problem in saline aquifer storage. However, current research shows that several trapping mechanisms immobilize the CO₂ underground, reducing the risk of leakage.

Another proposed form of carbon storage is in the oceans. Several concepts have been proposed including, for example, injection CO₂ into the water column at depths of 1,000 meters or more where the CO₂ subsequently dissolves due to the pressure, depositing CO₂ directly onto the sea floor at depths greater than 3,000 meters where CO₂ is denser than water and is expected to form a “lake” that would delay dissolution of CO₂ into the environment, converting the CO₂ to bicarbonates using limestone, or storing the CO₂ in solid clathrate hydrates already existing on the ocean floor or growing more solid clathrate. The environmental effects of oceanic storage are generally negative, but poorly understood.

Carbon sequestration by reacting naturally occurring minerals with CO₂ to form carbonates has many unique advantages. First, carbonates have a lower energy state than CO₂, which is why mineral carbonation is thermodynamically favorable and occurs naturally (e.g., the weathering of rock over geologic time periods). Secondly, the raw materials such as magnesium based minerals are abundant. Finally, the produced carbonates are unarguably stable and thus re-release of CO₂ into the atmosphere is not an issue.

In this process, CO₂ is reacted with abundantly available metal oxides (e.g., CaO, MgO, Na₂O, FeO, K₂O, and Fe₂O₃) and metal hydroxides (e.g., LiOH, NaOH, KOH, Mg(OH)₂, Ca(OH)) to form stable bicarbonates and carbonates. Examples of these reactions include:

CO₂+Mg(OH)→MgCO₃+H₂O

CO₂+NaOH→NaHCO₃

CO₂+2NaOH→Li₂CO₃+H₂O

CO₂+MgO→MgCO₃

These conventional carbonation pathways are slow under ambient temperatures and pressures, however, the reaction rate can be increase, for example by reacting at higher temperatures and/or pressures, or by pre-treatment of the minerals.

Both magnesium carbonate and calcium carbonate are very stable. Magnesium carbonate must be heated above 350° C. before it will re-release CO₂ and calcium carbonate must be heated to 825° C. before it will decompose. They are also insoluble or only sparingly soluble in water.

The carbonates and bicarbonates generated from these reactions are useful as raw materials in many commercial applications such as, for example, concrete block, slab, sheets and columns. In general, any silicate or aluminosilicate mineral that contains calcium or magnesium can undergo reactions that result in formation of a stable magnesium or calcium carbonate material. Additionally, they represent a means by which CO₂ can be permanently sequestered and are perhaps more attractive than schemes where CO₂ is simply injected into underground geologic formations.

Products such as NaOH are widely used commodity chemicals that readily capture CO₂, even upon exposure to the low levels of CO₂ found in air. However, it is likely more desirable to use naturally occurring minerals that react with CO₂ without the need for expensive pre-processing. Many industrial processes produce by-products that include high volumes of dusts, slags, sludges and artificially-broken rock such as mining overburden and tailings, which have the necessary fine size distribution to be highly reactive without further crushing and grinding. Examples of these materials include, but are not limited to, (1) cement-kiln dusts (CKD), which are finely-divided powders that are extremely rich in calcium oxides, calcium silicate glasses and other phases that readily undergo carbonation, (2) fly-ash, a by-product of coal combustion principally associated with electric power generating plants, which largely consists of calcium-rich aluminosilicate glasses, (3) mine overburden and tailing stockpiles, stone quarry sludges and similar mining residues that contain a broad variety of minerals amenable to carbonation, particularly feldspars, serpentines and other calcium or magnesium aluminosilicates, and (4) metallurgical slags, particularly iron and steelmaking slags, are rich in calcium compounds that can absorb CO₂. All of these materials contain varying amounts of oxides, particularly magnesium and calcium oxides, that can undergo carbonation reactions in the presence of water and like CKD, the industries that produce slags are also major emitters of carbon dioxide, and would benefit by being able to sequester a portion of their emissions by this means.

Thus, any mineral or industrial waste that contains either calcium or magnesium in non-carbonate forms, or iron in the Fe⁺² oxidation state, can be used for CO₂ sequestration. Other examples include, but are not limited to: Wollastonite (CaSiO₃); any of the pyroxene minerals such as, for example, diopside (MgCaSi₂O₆), hedenbergite (FeCaSi₂O₆), augite ((Ca, Mg, Fe)SiO₃), pigeonite ((Ca, Mg, Fe) (Mg, Fe) Si₂O₆), clinoenstatite (Mg₂Si₂O₆), or clinoferrosilite (Fe₂Si₂O₆); Serpentine minerals ((Mg, Fe)₃Si₂O₅(OH)₄); Epidote (Ca₂Al₂ (Fe,Al)(SiO₄)(Si₂O₇)O(OH). These products might find some other industrial use, or simply buried—safely sequestering CO₂.

These reactions can be carried out via direct contact of CO₂ with the solid metal oxide, hydroxide or mineral source or through a slurry containing the solid and a liquid solvent. The solvent can be a room-temperature ionic liquid (RTIL) or RTIL-amine solution. RTIL and RTIL-amine solvents possess unique physical properties such as non-volatility and thermal stability that are beneficial to improving industrial processes. The RTILs and RTIL-amine solvents exhibit high CO₂ capacities, and unique behaviors with respect to the capture of CO₂ by certain amines. These performance characteristics make CO₂ sequestration in combination with RTIL-amines and potentially viable process addition to RTIL-amine based CO₂ capture technologies.

The sequestration process might be carried within the regenerator, wherein the CO₂ captured by the RTIL-amine solvent is reacted directly to the sequestering solid. The reactions might also be carried out downstream from the regenerator using the CO₂ released from the RTIL-amine solvent, which could be compressed and contacted directly with the sequestering solid or a slurry. Because RTIL-amine solvents are of limited volatility, it is possible to produce CO₂ at a significantly higher partial pressure in the regenerator than in conventional aqueous amine solvents. The ability to generate high pressure CO₂ is likely to make the sequestering reactions proceed more rapidly than if used in combination with conventional aqueous amines systems.

The captured CO₂ also has the potential to be used for a negative carbon emission technique and/or supplement the production of algae. For example, the CO₂ can be introduced either separately or together with the incoming air into hydro-aeroponic greenhouses or photobioreactors to enhance production of agricultural crops such as vegetables, fruits and young trees. It is then possible to extend the growing season of crops and agriculture into cold climates with artificial lights using the electricity from the power plant to assist the carbon dioxide from the power plant. The CO₂ can also be used to make ethanol, methanol, ethylene, synthetic fuels, and other chemicals, or be used to grow algae with photosynthesis for making BioDiesel fuels.

The processes disclosed herein can also include monitoring the extraction (e.g., removal of impurity). For example, one can monitor the amount of the amine compound present in the mixture and provide addition of additional amount of the amine compound as needed. Such processes can be automated using a system comprising a central processing unit (e.g. a computer or other similar devices). Monitoring the amine compound in the mixture can be achieved by any of the analytical processes known to one skilled in the art. For example, one can sample the mixture to analyze the presence of the amine compound at a pre-determined intervals or randomly. Alternatively, the presence of the amine compound can be monitored continuously, for example, by providing a sampling window within the extraction vessel that allows monitoring of the amount of the amine compound by a suitable analytical technique such as, but not limited to, infrared analysis, UV/Vis analysis, nuclear magnetic resonance (NMR), etc. In this manner, a relatively constant or steady state level of the amine compound can be maintained within the extraction vessel.

The methods disclosed herein are suitable for removing various impurities (e.g., gases such as acid gases) from any fluid medium including, but not limited to, gaseous emission streams that comprise an acid gas or undesired gas, gases from natural sources as well as industrial emissions, and oil. Exemplary industries that produce a significant amount of acid gas that can be removed by methods of the present application include, but are not limited to, the energy industry (such as oil refineries, the coal industry, and power plants), cement plants, and the auto, airline, mining, food, lumber, paper, and manufacturing industries.

Some of the natural sources of CO₂ include the byproduct of metabolism, combustion or decay of an organism. In these instances, such sources can produce CO₂ with a carbon isotope make-up different from that of manufactured CO₂. For example, CO₂ from a natural source (e.g., wellhead, combustion of a fossil fuel, respiration of a plant or animal, or decay of garbage, etc.) would have a carbon isotope ratio that was relatively higher in ¹⁴C and/or ¹³C versus ¹²C. Such sources provide addition products from the CO₂ (e.g., carbamate) that are enriched in ¹⁴C and/or ¹³C relative to ¹²C. Compounds that are enriched in ¹⁴C and/or ¹³C are useful products in a variety of applications including, but not limited to, (i) general research uses that track carbon in vivo; (ii) diagnostic and research imaging technologies that could identify the new compound from in vivo background, such as MRI (e.g., in vivo tumor detection). Accordingly, the present application discloses methods for using a natural CO₂ source and products (e.g., carbamate) created using such natural CO₂ sources that have enriched ¹⁴C and/or ¹³C isotopes.

Additional objects, advantages, and novel features disclosed herein will become apparent to those skilled in the art upon examination of the following examples thereof, which are not intended to be limiting.

### EXAMPLES

### Materials and General Procedures

All syntheses and manipulations were performed in air. All chemicals were purchased from Sigma-Aldrich (Milwaukee, Wis.), with the exception of lithium bis(trifluoromethane)sulfonamide (LiTf₂N), which was obtained from 3M (St. Paul, Minn.). All chemicals were obtained in the highest purity grade possible from these suppliers, and were used as received. All gases including CO₂ were of at least 99.99% purity and purchased from Air Gas (Radnor, Pa.).

### Instrumentation

¹H NMR data were obtained using a Varian INOVA 400 Spectrometer (400 MHz). Water content (ppm) in [C₆mim][Tf₂N] and [C₂OHmim][Tf₂N] was determined using a Mettler Toledo DL32 Karl Fischer coulometer. A Thermolyne MaxiMix Plus vibrating mixer was used for homogenizing RTIL-amine solutions. The stainless steel cell used in CO₂ uptake experiments was custom fabricated. Pressure sensors (PX303) were purchased from Omega. Automated data acquisition was performed using LabView (National Instruments) interfaced through a custom system.

### Synthesis of 1-hexyl-3-methylimidazolium bis(trifluoromethane)sulfonamide (2a)

1-Methylimidazole (103.50 g, 1.2605 mol) was dissolved in CH₃CN (500 mL) in a 1-L round-bottom flask. 1-Bromohexane (228.98 g, 1.3872 mol) was then added, and the reaction mixture heated at reflux for 16 h. The reaction was then stopped, the solvent removed by rotary evaporation, and Et₂O (300 mL) added, resulting in the formation of two phases. The denser, oily phase was stirred in Et₂O for several hours at ambient temperature. Both phases were then poured into deionized H₂O (1 L), and the aqueous phase was then separated from the Et₂O phase. The aqueous phase was washed with EtOAc (3×500 mL) and then collected in a 2-L round-bottom flask. LiTf₂N (398.21 g, 1.3871 mol) was added to the aqueous phase, and an oily phase immediately separated. The mixture was subsequently vigorously stirred for 24 h to ensure thorough mixing in this large vessel. After this time, the oily phase was extracted into CH₂Cl₂ (750 mL) and washed with deionized H₂O (4×500 mL). The fifth aqueous washing was exposed to AgNO₃, to confirm that residual bromide anion was no longer present via the lack of AgBr precipitate formation. The organic phase was then dried over anhydrous MgSO₄, treated with activated carbon, and filtered through a plug of basic Al₂O₃. The solvent was then removed by rotary evaporation, and the final product was dried while stirring at 65° C. under dynamic vacuum (<1 ton) for 16 h. The product 2a was obtained as a clear pale yellow oil. Yield: 464.05 g (82%). The water content in the product was found to be 217 ppm by Karl-Fischer titration.

### Synthesis of 1-(2-hydroxyethyl)-3-methylimidazolium bis(trifluoromethane)sulfonimide (2b)

1-Methylimidazole (77.63 g, 0.9454 mol) was dissolved in CH₃CN (200 mL) in a 1-L round-bottom flask. 2-Chloroethanol (114.12 g, 1.4174 mol) was then added, and the reaction stirred at reflux for 72 h. After this time, the reaction was stopped, and the solvent removed via rotary evaporation. Et₂O (500 mL) was then added, resulting in the formation of two phases. The mixture was then placed in a freezer at −10° C. Upon cooling for several hours, colorless crystals formed. These crystals were then collected, washed with Et₂O (1 L), and dried at ambient temperature under dynamic vacuum (<1 torr) overnight, yielding 124.35 g (8 1%) of 1-(2-hydroxyethyl)-3-methylimidazolium chloride. The 1-(2-hydroxyethyl)-3-methylimidazolium chloride (50.00 g, 0.3110 mol) was then dissolved in deionized H₂O (300 mL), to which LiTf₂N (89.28 g, 0.3110 mol) was added to immediately form a separated oily phase. The reaction was then stirred overnight at ambient temperature, after which the oily phase was extracted with EtOAc (500 mL) and washed with deionized H₂O (4×250 mL). The absence of chloride anion was confirmed through addition of AgNO₃ to the fourth aqueous washing, without any AgCl precipitate formation. The organic phase was then dried over anhydrous MgSO₄, treated with activated carbon, and filtered through a plug of basic Al₂O₃. The solvent was removed via rotary evaporation, and the product dried under dynamic vacuum (<1 torr) while stirring at 65° C. overnight to produce 2b as a clear, colorless oil. Yield: 60.58 g (48%). The water content in the product was found to be 225 ppm by Karl-Fischer titration.

### General Procedure for the Formulation of RTIL-Amine Solutions

Solutions of RTILs with amines (50:50 (mol:mol)) were prepared for comparison with amine-functionalized TSILs, which contain one 1° amine group per ion pair. RTIL 2a (10.00 g, 22.35 mmol) was mixed with MEA (1.365 g, 22.35 mmol) in a 20-mL glass vial. The vial was sealed and the liquids were held on a vibrating mixer, typically for <10 s, until a homogeneous solution was achieved. This procedure was repeated for 2a-MDEA, 2b-MEA, and 2b-DEA.

Preparing RTIL-Amine Mixtures with >50 mol % Amine Content

RTILs 2a and 2b were miscible with MEA in all proportions. Solutions containing >50 mol % MEA content were prepared in the same manner as those with 50 mol % content, as outlined above. No phase separation was observed at for any mixture with >50 mol % of MEA. Analogously 2a was miscible with MDEA in all proportions. Similarly, 2b was miscible with DEA, and solutions of 2b-DEA with >50 mol % DEA were also prepared. MEA is typically dissolved in water at 30 wt % (˜5 mol/L) in industrial processes.

### CO₂ Uptake

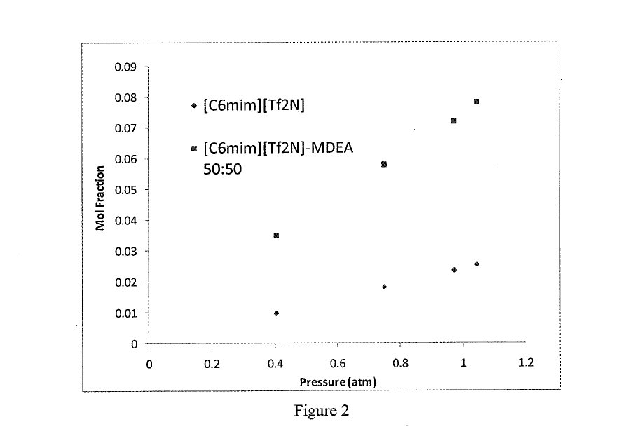

To assess CO₂ uptake as a function of pressure in a mixture of a tertiary amine and an RTIL compared to pure RTIL, MDEA was dissolved in 2a as 50:50 (mol:mol) solution. In the study, solutions were loaded into a sealed vessel of known volume, heated to 40° C. and exposed to CO₂ at pressures ranging from 0.4 atm to more than 1 atm with stirring. As can been seen in FIG. 2, the addition of MDEA to 2a enhanced CO₂ uptake compared to uptake by 2a alone. The effect was particularly notable at a pressure of about 1 atm.

### CO₂ Capture

CO₂ uptake experiments in RTIL-amine solutions were performed using a dual-volume, dual-transducer apparatus. Briefly, an aliquot of RTIL-amine solution of known mass and volume was sealed in a stainless steel cell of known volume. The cell was heated to 40° C. and purged under dynamic vacuum (<10 ton) for a short time to remove any residual air from the system. CO₂ was then introduced at ˜1 atm. As the CO₂ reacted with the amines, the pressure in the cell was observed to decay and was recorded electronically as a function of time. The difference between the initial and final CO₂ pressures was converted into moles of CO₂ reacted with amine using the ideal gas equation:

$${n}_{{co}_{2}} = \frac{Δ PV}{RP}$$

Complexation and decomplexation of CO₂ from amines were performed at 40° C. and 100° C.
CO₂ Capture and Release with Equimolar 2a-MEA Solutions

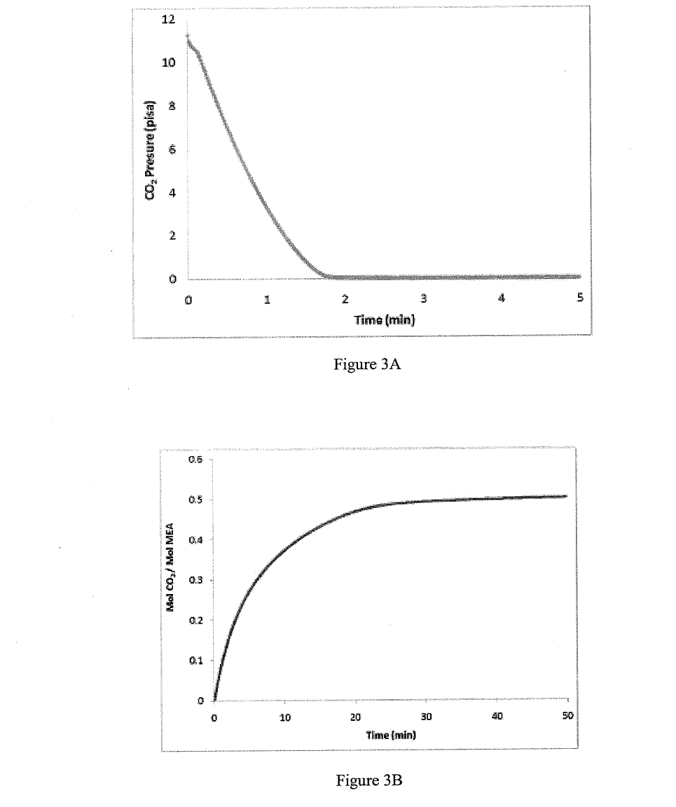

FIG. 3A is an example of the pressure decay of CO₂ in an equimolar solution of 2a-MEA. FIG. 3A shows that the CO₂ concentration in the gas feed was rapidly reduced and effectively brought to zero using an equimolar 2a-MEA solution. These solutions can be rapidly stirred to increase the reaction rate. The final pressure of CO₂ in FIG. 3A is 0±0.015 psia, where 0.015 psia is the accuracy limit of the pressure sensor used. The reaction of CO₂ was favored by MEA-carbamate precipitating from the RTIL solutions.

FIG. 3B shows the rate of conversion of CO₂ to MEA-carbamate salt of the system 2a-MEA. Capture of CO₂ was greater than about 90% within 15 minutes and the reaction was complete after 25 minutes.

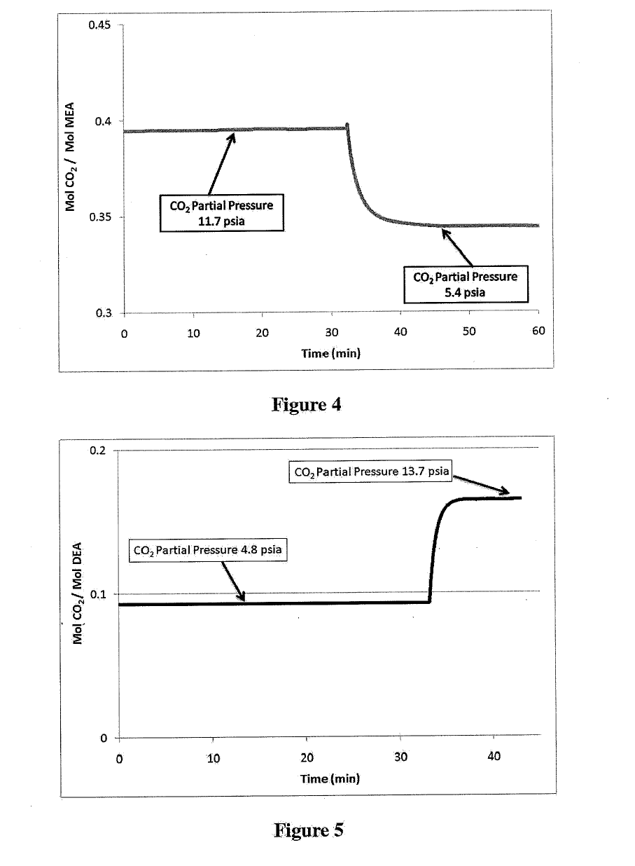

CO₂ was decomplexed from MEA-carbamate by increasing the temperature to from 40° C. to 100° C. and reducing the pressure from 605 ton (11.7 psia) to 279 torr (5.4 psia), which favors the release of CO₂ and reformation of neutral MEA. FIG. 4 shows the rate of CO₂ release from MEA-carbamate in 2a. Upon reducing the system pressure, to remove some CO₂ from the cell volume, the ratio of CO₂ to amines was reduced from 0.395 with a CO₂ partial pressure 11.7 psia to 0.350 with a CO₂ partial pressure of 5.4 psia within 2 minutes. The initial value of 0.395 is less than the ratio of 0.500 that was achieved from complete capture at 40° C. This is a consequence of heating from 40° C. to 100° C., as some CO₂ had already been released.

CO₂ Capture and Release with Equimolar 2b-DEA Solutions

CO₂ reacts with DEA in 2b with CO₂ at low pressure to achieve loading levels similar to what can be achieved in aqueous solutions. It is believed that DEA-carbamate is a weaker CO₂-adduct than MEA-carbamate, thus the moles of CO₂ captured by DEA are less than 1:2 at the equilibrium pressure of 30.4 ton (0.588 psia). An equilibrium pressure of ˜155 ton (3 psia) was required to achieve a 1:2 ratio of CO₂:DEA.

An added benefit of the 2b-DEA solutions is that increasing the partial pressure of CO₂, even at elevated temperatures, resulted in increased uptake of CO₂ by equimolar 2b-DEA solutions. See FIG. 5. The molar ratio of CO₂ to DEA increased from 0.093 to 0.165 with increasing CO₂ partial pressure from 248 torr (4.8 psia) to 708 ton (13.7 psia) at 100° C. Although aqueous amine solutions are near their boiling points at this temperature, RTILs are effectively non-volatile at 100° C.

### Solubility of Various Gases in Ionic Liquids

1-Ethyl-3-methylimidazolium tetrafluoroborate ([C₂mim] [BF₄]) and 1-ethyl-3-methylimidazolium bis-(trifluoromethanesulfonyl)imide ([C₂mim] [Tf₂N]) were synthesized according to the procedures described herein. Physical constants of the RTILs (pure and mixtures) are shown in Table 1. The densities of [C₂mim][BF₄] and [C₂mim][Tf₂N] were measured. The average densities of the RTIL mixtures were also measured; these RTILs were readily miscible in each other when mixed, and represent a range of molar volumes.

TABLE 1
Physical Properties of Room-Temperature
Ionic Liquids Used in This Study

| | mol. weight | density | molar volume |
|---|---|---|---|
| ionic liquid | (g/mol) | (g/cm³) | (cm³/mol) |
| [C₂mim][Tf₂N] | 391 | 1.50 | 261 |
| 25 mol % [C₂mim][BF₄] + | 343 | 1.52 | 226 |
| 75 mol % [C₂mim][Tf₂N] | | | |
| 50 mol % [C₂mim][BF₄] + | 295 | 1.48 | 199 |
| 50 mol % [C₂mim][Tf₂N] | | | |
| 75 mol % [C₂mim][BF₄] + | 246 | 1.42 | 174 |
| 25 mol % [C₂mim][Tf₂N] | | | |
| 90 mol % [C₂mim][BF₄] + | 217 | 1.35 | 161 |
| 10 mol % [C₂mim][Tf₂N] | | | |
| 95 mol % [C₂mim][BF₄] + | 208 | 1.30 | 159 |
| 5 mol % [C₂mim][Tf₂N] | | | |
| [C₂mim][BF₄] | 198 | 1.28 | 155 |

Additionally, experimental observations and RST have shown that all gases of interest have higher solubility in [C₂mim][Tf₂N] and lower solubility in [C₂mim][BF₄]. However, the solubility selectivity for CO₂ with respect to N₂ and CH₄ is higher in [C₂mim][BF₄] than in [C₂mim][Tf₂N]. These experiments examined how the combination of the two RTILs properties affect gas solubility behaviors and how to extend regular solution theory (RST) to describe these behaviors in RTIL mixtures.

To determine if the gas-liquid system equilibrium had been reached, the pressure in the cell volume was plotted as a function of time (one measurement per min). After 30 min of constant pressure readings, it was assumed that equilibrium had been reached. All trials displayed similar pressure change behaviors. For each trial, the Henry's constant (“H_{c}”) was determined from the ideal gas law using the difference between Pₜ₌₀ and P_{equil} at each temperature.

Table 2 shows the experimental Henry's constants for each gas/RTIL mixture combination. The Henry's constant for CO₂ and CH₄ increased with increasing [C₂mim][BF₄] content. The Henry's constant for N₂ increased with increasing [C₂mim][BF₄] content, except in pure [C₂mim][BF₄], where the Henry's constant decreased.

TABLE 2
Gas Solubility Trends in RTIL Mixtures

| | CO₂/H_{c} | N₂/H_{c} | CH₄/H_{c} |
|---|---|---|---|
| ionic liquid | (atm) | (atm) | (atm) |
| [C₂mim][Tf₂N] | 50 ± 1 | 1200 ± 60 | 560 ± 10 |
| 25 mol % [C₂mim][BF₄] + | 58 ± 3 | 1700 ± 60 | 740 ± 10 |
| 75 mol % [C₂mim][Tf₂N] | | | |
| 50 mol % [C₂mim][BF₄] + | 65 ± 1 | 2400 ± 100 | 980 ± 20 |
| 50 mol % [C₂mim][Tf₂N] | | | |
| 75 mol % [C₂mim][BF₄] + | 85 ± 5 | 4000 ± 600 | 1600 ± 20 |
| 25 mol % [C₂mim][Tf₂N] | | | |
| 90 mol % [C₂mim][BF₄] + | 91 ± 1 | 4500 ± 350 | 1800 ± 60 |
| 10 mol % [C₂mim][Tf₂N] | | | |
| 95 mol % [C₂mim][BF₄] + | 94 ± 1 | 5000 ± 300 | 1900 ± 20 |
| 5 mol % [C₂mim][Tf₂N] | | | |
| [C₂mim][BF₄] | 100 ± 2 | 3800 ± 100 | 2000 ± 200 |

RST dictates that for low pressure systems, where Henry's law is applicable, gas solubilities (Henry's constant, H₁) can be described by solubility parameters using eq 1 for both the solute and the pure solvent (1=RTIL, 2=gas) and where a and b are empirically determined constants (depending on gas being used and temperature).

ln[H_{2,1}]=α+b(δ₁−δ₂)² (1)

The solubility parameter (δ₁) for pure imidazolium-based RTILs can be estimated using the Kapustinskii equation for lattice energy density and the definition of a solubility parameter. This substitution results in a solubility parameter that is a function of pure RTIL molar volume (eq 2).

δ¹∝[1/(V₁^{4/3})]^{1/2} (2)

Specifically for mixtures, RST states that a volume fraction averaged solubility parameter (δ₁), and related volume fraction averaged molar volume (V₁) for the solvent be used in theoretical calculations (eqs 3 and 4), where is φᵢ the volume fraction and Vᵢ of each pure solvent.

$$\begin{matrix}{δ}_{1} = {\sum }_{i} {ϕ}_{1} {δ}_{1} & ( 3 ) \\ {\overline{V}}_{1} = {\sum }_{i} {ϕ}_{1} {V}_{1} & ( 4 )\end{matrix}$$

By combining eqs 1 and 2, the RST model results in eqs 5 and 6, where α and β or β* are experimentally determined constants that are dependent on the temperature and gas being tested.

$$\begin{matrix}ln ( {H}_{2 , 1} ) = α + {β ( {δ}_{1} )}^{2} & ( 5 ) \\ ln ( {H}_{2 , 1} ) = α + ( \frac{{β}^{*}}{{Vi}^{4 / 3}} ) & ( 6 )\end{matrix}$$

It has shown that lower molar volumes tend to have higher ideal solubility selectivities for CO₂. However, in general the theory is less accurate in the low molar volume range.

To determine if the mixtures can be described by RST, a plot was made of the Henry's constant versus the volume fraction average molar volume of the RTIL mixtures, as dictated by RST (eqs 3 and 4). However, use of the volume fraction average mixture molar volume did not result in a quality linear fit for the RST model, which indicated that RST was not a perfect model. Without being bound by any theory, it is believed that this was due to the physical volume change that resulted from mixing the two RTILs. The measured mixture molar volume was not the same as the volume fraction average mixture molar volume (2-6% difference between the measured and calculated values). The difference in the mixture molar volumes indicated that RST was not a robust model; however, using the measured mixture molar volume (empirical data) and the RST equations allowed for the investigation of gas solubility trends in RTILs. Therefore, the average measured mixture molar volume was used in the following plots because it allowed for a more accurate description of the experimentally observed behaviors while using the RST model. For the case of an unknown mixture molar volume, however, it would still be possible to use the volume fraction average mixture molar volume from the known pure component molar volume to get an initial estimate for the gas solubility behavior being investigated. While RST is not exact, it can be used to obtain initial predictions for gas solubilities in new RTILs.

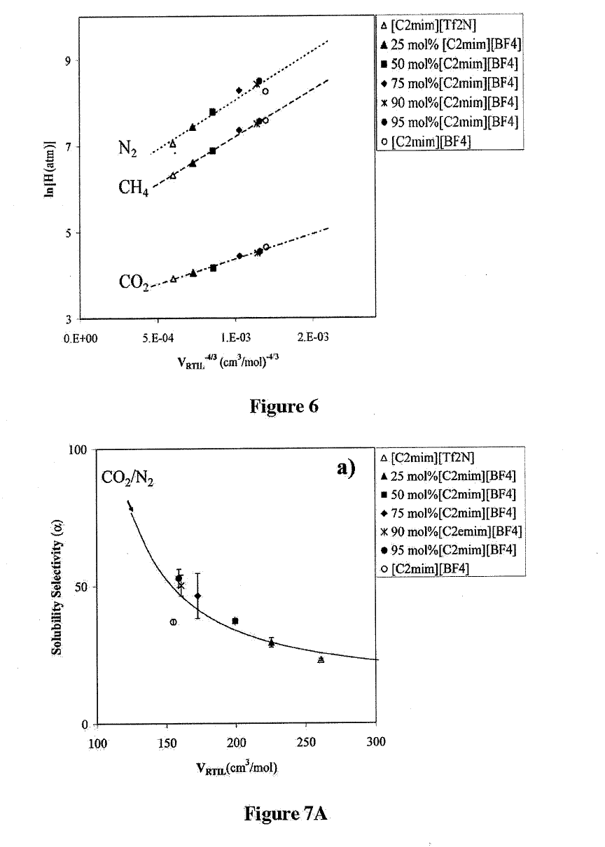

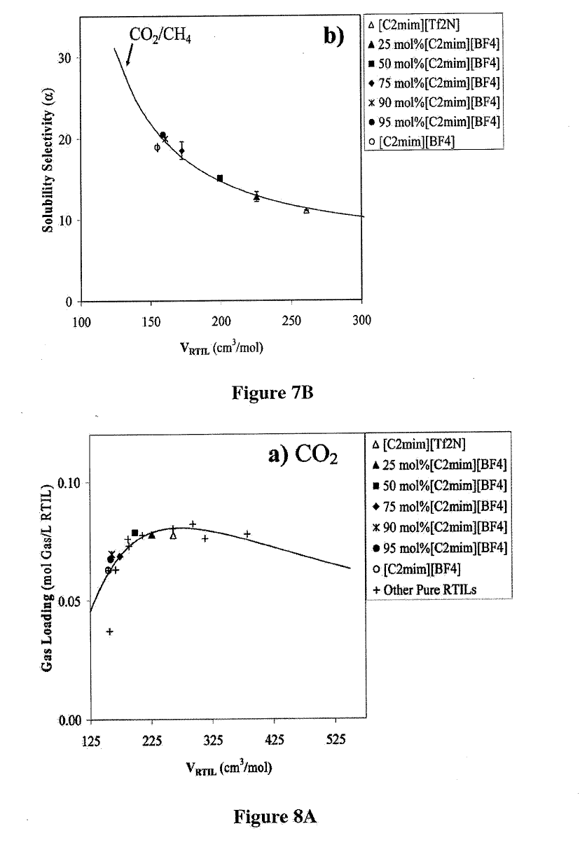

FIG. 6 shows a linear trend for the natural log of the Henry's constants for each gas with respect to average measured mixture molar volume at 40° C. All data shown, including mixtures and pure components, were within the 95% confidence intervals (not shown) of the theoretical line. RST was thus valid for the gas/RTIL mixtures combinations that were investigated. Since RST was valid for these systems, it was expected that lower mixture molar volumes would result in the higher solubility selectivity as shown in FIGS. 7A and 7B. As can be seen, the mixture solubility selectivity agreed with the theoretical line, indicating that RST can be used to describe the behavior of RTIL mixtures using measured molar volumes. All data shown were within the 95% confidence intervals (not shown) of the model. The pure [C₂mim][BF₄] solubility selectivity for both CO₂/N₂ and CO₂/CH₄ did not as closely agree (as compared with the other mixtures and [C₂mim][Tf₂N]) with the theoretical prediction, whereas the 90 and 95 mol % [C₂mim] [BF₄] mixtures, at the lower molar volume range of this study, possessed the higher solubility selectivity closer to the RST prediction. Addition of a small amount of [C₂mim][Tf₂N] to [C₂mim][BF₄] resulted in an improved solubility selectivity behavior closer to the theoretical prediction.

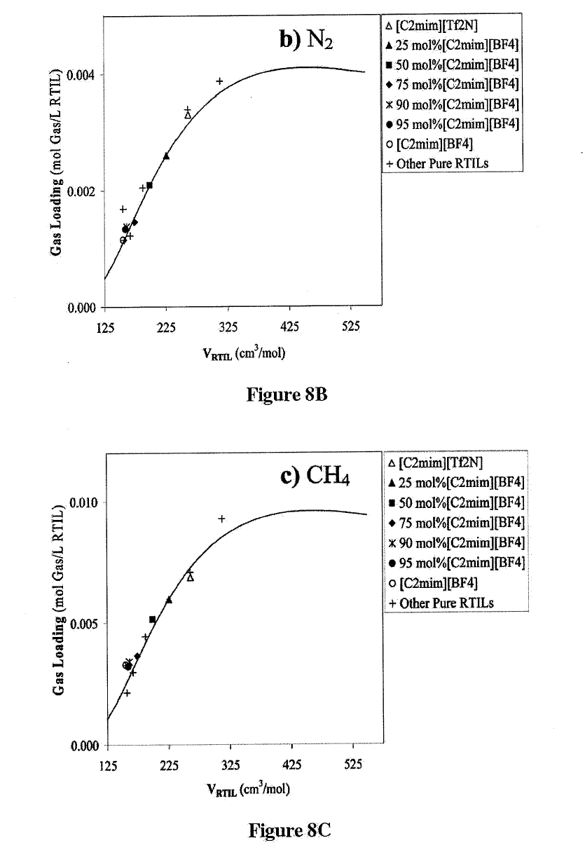

For each gas, the gas loading at 1 atm, or mole fraction of gas dissolved in the RTIL that is in equilibrium with vapor phase, was also examined. FIGS. 8A-C show the results for each gas. These plots used the theoretical parameters to show that the pure component theory could be extended to describe the mixture data. The pure component data for CO₂ includes the following RTILs: 1-butyl-3-methylimidazolium hexafluorophosphate ([C₄mim][PF₆]), 1-butyl-3-methylimidazolium tetrafluoroborate ([C₄mim][BF₄]), 1-butyl-3-methylimidazolium bis[(trifluoromethyl)sulfonyl]imide ([C₄mim][Tf₂N]), 1,3-dimethylimidazolium methylsulfate ([C₁mim][MeSO₄]), 1-hexyl-3-methylimidazolium bis[(trifluoromethyl)sulfonyl]amide ([C₆ mim][Tf₂N]), 1-ethyl-3-methylimidazolium trifluoromethanesulfonate ([C₂mim] [CF₃SO₃]), 1-ethyl-3-methylimidazolium dicyanamide ([C₂mim] [dca]), 1-decyl-3-methylimidazolium trifluoromethanesulfonate ([C₁₀mim][Tf₂N]), [C₂mim][BF₄], and [C₂mim][Tf₂N]. The pure component data for N₂ and CH₄ included the following RTILs: 1,3-dimethylimidazolium methylsulfate ([C₁mim][MeSO₄]), 1-hexyl-3-methylimidazolium bis[(trifluoromethyl)sulfonyl]amide ([C₆mim][Tf₂N]), 1-ethyl-3-methylimidazolium trifluoromethanesulfonate ([C₂mim][CF₃SO₃]), 1-ethyl-3-methylimidazolium dicyanamide ([C₂mim][dca]), [C₂mim][BF₄], and [C₂mim][Tf₂N]. A summary of the pure component data is shown in Table 3.

TABLE 3
Gas Loading at 1 atm and 40° C. for Various Pure RTILs.

| | | gas loading at 1 atm | | |
|---|---|---|---|---|
| | molar volume | (mol gas/RTIL) | | |
| ionic liquid | (cm³/mol) | CO₂ | N₂ | CH₄ |
| [C₁mim][MeSO₄] | 157 | 0.037 | 1.1E−03 | 2.1E−03 |
| [C₂mim][dca] | 167 | 0.063 | 1.2E−03 | 3.0E−03 |
| [C₂mim][CF₃SO₃] | 188 | 0.076 | 2.1E−03 | 4.43−03 |
| [C₄mim][BF₄] | 189 | 0.073 | | |
| [C₄mim][PF₆] | 211 | 0.078 | | |
| [C₄mim][Tf₂N] | 293 | 0.082 | | |
| [C₆mim][Tf₂N] | 313 | 0.076 | 3.9E−03 | 9.3E−03 |
| [C₁₀mim][Tf₂N] | 382 | 0.078 | | |

All mixture data points agreed well (within the 95% confidence intervals) with the theoretical predictions for pure RTILs, and each gas exhibited a maximum gas loading at different molar volumes.

The experimental results indicated that the behavior of gases in RTIL mixtures at constant temperature and low pressure obey RST. Solubility selectivity for CO₂ with N₂ and CH₄ was higher in the 90 and 95 mol % mixtures of [C₂mim][BF₄] in [C₂mim][Tf₂N] than in both pure components or the other mixtures. These two mixtures represent the RTIL mixtures with the smaller molar volumes in this study, and the solubility selectivity was higher than in pure [C₂mim][BF₄], which has an even lower molar volume. These data showed that RST can be used in RTIL mixtures using the average measured molar volume of the mixture. The results showed that RTIL mixtures can be used to enhance CO₂ solubility selectivity due to the control over RTIL molar volume. CO₂ was more soluble compared to N₂ or CH₄ in RTIL mixtures tested. Each gas exhibited a maximum gas loading at 1 atm at a different molar volume.

### Mixture of Amine Compounds

Mixtures of different ionic liquids (ILs) and different amines can be varied to tailor performance to different pressures and gas compositions. By using a combination of different ILs the solubility and solubility selectivity of gases can be adjusted (as shown above). This property of ILs can then be applied to adjust reaction rates and reduce other undesirable gas solubility (e.g., hydrocarbon solubility for natural gas sweetening or oxygen solubility for flue gas) for IL/amine applications. A combination of different amines (e.g., MEA and N-methyldiethanolamine (MDEA)) in IL/amine applications can be use to adjust the point of carbamate precipitation or prevent carbamate precipitation depending on the ratio. This has many advantages which include control of viscosity, reaction rate, amine acid gas loading, heat of reaction, and corrosion.

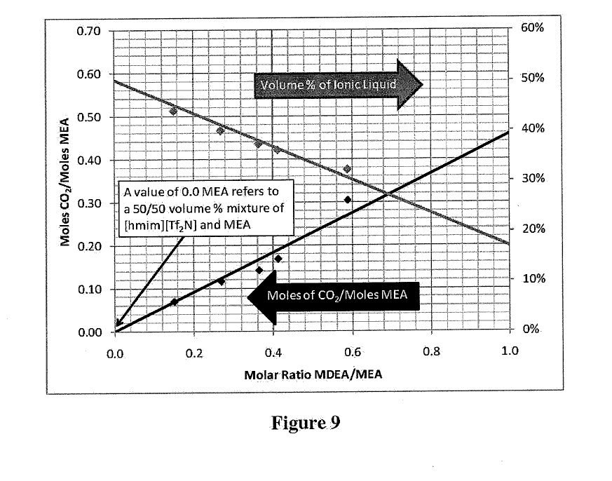

FIG. 9 shows an example of using more than one amine in an IL/amine solution. An initial solution of 50 volume % MEA and 50% volume % [C₆mim][Tf₂N] was made (a value of 0.0 MEA refers to a 50/50 volume % mixture of [C₆mim][Tf₂N] and MEA). When the solution was exposed to CO₂ there was immediate carbamate precipitation. Methyldiethanolamine was then added to the solution to act as a proton acceptor, which increased the carbamate solubility forming a homogenous solution. The solution was once again exposed to CO₂ and carbamate precipitation occurred at an elevated amine acid gas loading. Additional MDEA was added and then the process was repeated. The results are shown in FIG. 9 where the black line shows the point of precipitation and the grey line shows the volume percent of IL in the solution. By controlling the point of precipitation, reaction rate can be controlled independently of acid gas loading and acid gas pressure equilibrium.

In addition to imidazolium-based ILs, amines are also miscible in pyridinium-based ILs, ammonium-based ILs, phosphonium-based ILs.

The foregoing discussion of the invention has been presented for purposes of illustration and description. The foregoing is not intended to limit the invention to the form or forms disclosed herein. Although the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

The patents and publications listed herein describe the general skill in the art and are hereby incorporated by reference in their entireties for all purposes and to the same extent as if each was specifically and individually indicated to be incorporated by reference. In the case of any conflict between a cited reference and this specification, the specification shall control.

What is claimed is:

1. A method of capturing and sequestering an impurity gas from a fluid stream comprising:
contacting the fluid stream with an impurity removing mixture, the mixture comprising an ionic liquid and an amine compound under conditions sufficient to reduce the amount of impurity gas from said fluid stream; and
reacting the impurity gas with a sequestration material, wherein the sequestration material comprises a metal oxide or a metal hydroxide.

2. The method of claim 1, wherein the ionic liquid comprises a non-carboxylate anion.

3. The method of claim 1, wherein the amine compound comprises a monoamine, a diamine, a polyamine, a polyethylene amine, an amino acid, a neutral N-heterocycle or a neutral N-heterocyclic-alkyl-amine.

4. The method of claim 1, wherein the metal oxide comprises an alkaline earth metal.

5. The method of claim 1, wherein the metal oxide is selected from the group consisting of CaO, MgO, Na₂O, FeO, K₂O, Fe₂O, or a combination thereof.

6. The method of claim 1, wherein the sequestration material includes material selected from the group consisting of wollastonite, yroxene minerals, hedenbergite, augite, pigeonite, clinoenstatite, clinoferrosilite, serpentine minerals, epidote, or a combination thereof.

7. The method of claim 1, wherein the metal hydroxide is selected from the group consisting of LiOH, NaOH, KOH, Mg(OH)₂, Ca(OH)₂, or a combination thereof.

8. The method of claim 1, wherein the impurity gas comprises CO₂, CO, COS, H₂S, SO₂, NO, N₂O, an alkyl mercaptan, H₂O, O₂, H₂, N₂, a C₁-C₈ chain hydrocarbon, or a combination thereof.

9. The method of claim 8, wherein the impurity gas comprises CO₂, H₂S, SO₂, or a combination thereof.

10. The method of claim 9, wherein the impurity gas comprises CO₂.

11. The method of claim 3, wherein the monoamine compound is selected from the group consisting of monoethanolamine, diglycolamine, diethanolamine, diisopropylamine, triethanolamine, methyldiethanolamine, or a combination thereof.

12. The method of claim 1, wherein the amine compound is a heteroalkylamine compound.

13. The method of claim 2, wherein the ionic liquid is a room temperature ionic liquid (RTIL).

14. The method of claim 13, wherein said step of contacting the fluid medium with the impurity removing mixture is conducted under pressure.

15. The method of claim 13, wherein the fluid medium comprises natural gas, oil, or a combination thereof.

16. The method of claim 13, wherein said step of contacting the fluid medium with the impurity removing mixture produces a complex between the impurity and the amine compound.

17. The method of claim 1, further comprising regenerating the impurity removing mixture.

18. A method of capturing and sequestering an impurity gas from a fluid stream comprising:
contacting the fluid stream with an impurity removing mixture, the mixture comprising an ionic liquid and an amine compound under conditions sufficient to reduce the amount of impurity gas from said fluid stream; and
regenerating off the impurity from the mixture,
wherein the ionic liquid comprises a non-carboxylate anion; and
wherein the amine compound comprises a monoamine, a diamine, a polyamine, a polyethylene amine, an amino acid, a neutral N-heterocycle or a neutral N-heterocyclic-alkyl-amine.

19. The method of claim 17, wherein the step of regenerating off the impurity from the mixture comprises heating the mixture in one or more reboilers.

20. The method of claim 17, wherein the step of regenerating off the impurity from the mixture comprises reducing the pressure on the mixture in one or more reboilers.

21. A method of capturing and sequestering an impurity gas from a fluid stream comprising:
contacting the fluid stream with an impurity removing mixture, the mixture comprising an ionic liquid and an amine compound under conditions sufficient to reduce the amount of impurity gas from said fluid stream;
releasing the impurity gas from the impurity removing mixture; and
delivering the impurity gas to a bioreactor.

22. The method of claim 21, wherein the impurity gas comprises CO₂, CO, COS, H₂S, SO₂, NO, N₂O, an alkyl mercaptan, H₂O, O₂, H₂, N₂, a C₁-C₈ chain hydrocarbon, or a combination thereof.

23. The method of claim 22, wherein the impurity gas comprises CO₂.

24. The method of claim 23, wherein the bioreactor includes microorganisms selected to convert CO₂ to BioDiesel, ethanol, or a combination thereof.

25. The method of claim 24, wherein the microorganism includes algae.
